(19) United States
(12) Patent Application Publication
(10) Pub. No.: US 2025/0015437 A1
(43) Pub. Date: Jan. 9, 2025

(54) SEPARATORS FOR USE IN ENERGY STORAGE DEVICES

(71) Applicant: BOARD OF REGENTS, THE UNIVERSITY OF TEXAS SYSTEM, Austin, TX (US)

(72) Inventors: David MITLIN, Austin, TX (US); Pengcheng LIU, Austin, TX (US)

(21) Appl. No.: 18/576,920

(22) PCT Filed: Jul. 7, 2022
(86) PCT No.: PCT/US2022/036318

§ 371 Date: Jan. 5, 2024

Related U.S. Application Data
(60) Provisional application No. 63/219,259, filed on Jul. 7, 2021.
(60) Provisional application No. 63/277,247, filed on Nov. 9, 2021.

(51) Int. Cl. H01M 50/451; H01M 4/02; H01M 4/38; H01M 50/403; H01M 50/414; H01M 50/431; H01M 50/457

(52) U.S. Cl. CPC H01M 50/451; H01M 4/382; H01M 50/403; H01M 50/414; H01M 50/431; H01M 50/457; H01M 2004/027; H01M 2004/028

(57) ABSTRACT

Disclosed is a multifunctional structure comprising: a first layer comprising a first polymer and having a first surface and a second surface, and a second layer comprising an inorganic-based material deposited on at least the first surface of the first layer, wherein the structure is an electrochemical cell separator. Also disclosed are electrochemical cells comprising the same and methods of making the same.

### CROSS-REFERENCE TO RELATED APPLICATIONS

This application claims the benefit of U.S. Provisional Application No. 63/219,259, filed Jul. 7, 2021, and U.S. Provisional Application No. 63/277,247, filed Nov. 9, 2021, the contents of which are incorporated herein by reference in their entirety.

### STATEMENT ACKNOWLEDGING GOVERNMENT SUPPORT

This invention was made with government support under Grant nos. DE-SC0018074, DE-AC05-00OR22725, DE-AC52-06NA25396, and DE-NA0003525 awarded by the Department of Energy. The government has certain rights in the invention.

### TECHNICAL FIELD

This application relates generally to electrochemical cell separators having at least one surface of a first layer covered with a layer of an inorganic material.

### BACKGROUND

Since the invention of the “true battery” by Volta in 1800, batteries have become so essential that it is impossible to envision modern life existence without batteries. All aspects of humankind's life today require the use of batteries. A magnitude of various applications requires a wide variety of batteries both from an energy storage perspective and from a size perspective.

Li metal is considered the “Holy Grail” of electrode materials. Many various lithium metal batteries have been developed in the last few decades. Additional electrode materials are also considered. For example, potassium metal batteries (KMBs, PMBs) and potassium ion batteries (KIBs, PIBs) attract increasing scientific attention. The targeted application for potassium-based electrochemical storage is various stationary electrical energy storage systems (ESSs), where there may be cost and supply advantages over lithium-ion batteries (LIBs). The mineral precursors employed for KMBs and KIBs are more abundant than those employed for LIBs, while not directly competing with automotive applications. Potassium-based electrochemical energy storage systems may also possess electrochemical advantages because K ions possess weaker Lewis acidity, smaller Stokes' radius, and higher mobility than Li or Na in both ester and ether electrolytes. These are yet to be realized for KMBs in large part owing to the potassium anode reactivity issues described below.

Due to its high reactivity with organic electrolytes, the K metal anode, similar to Li metal anodes (and Na metal anodes), may suffer from an unstable solid electrolyte interphase (SEI) and the associated growth of dendrites. Growth of K (Li, Na) dendrites is a complicated phenomenon related to a number of factors, including the non-uniform diffusion of K (Li, Na) ions and electrons and the chemical and electrochemical reactions at the anode-electrolyte interphase. It is understood that the desired properties for an efficient SEI include ionic conductivity and electronic insulation to allow hindering the transport of electrons from the anode to the electrolyte and therefore minimizing further decomposition of the electrolyte during cycling. Moreover, it is desired that the formed SEI is uniform across the entire metal-electrolyte interface in terms of its thickness and phase distribution, which would promote homogenous diffusion fields during plating and stripping. However, owing to a number of effects such as poor electrolyte and metal wettability, the formed SEI is heterogenous in both respects. Dendrite growth, therefore, is endemic, with low Coulombic efficiency (CE), “dead metal” that is isolated from the current collector, severe increase in cell impedance, and potentially catastrophic shorting failure being the result.

Various approaches were implemented to stabilize the K (Li or Na) metal-electrolyte interface, resulting in improved cycling stability. There have been various approaches that may be subdivided into the modified electrolyte and additive formulations, the design of more stable artificial SEI layers and more planar “electrochemically polished” interfaces, and the design of various K (Li, Na) metal hosts. For example, it was reported that Joule heating through high current pulses could result in the thermal rounding of dendrites as well as the annealing of the SEI structure. It was also recently demonstrated that a combination of geometrical enhancement through a 3D support (reduced current density) and improved electrochemical wetting (elimination of island growth) leads to optimum cycling performance and that each effect separately was insufficient.

Polypropylene (PP) and polyolefin (PE) separators are the working standards for LIBs and Li metal batteries. Instead, glass fiber frit separators are most often employed for KMBs as well as for sodium metal batteries. There are multiple reasons why glass frits are more effective with K and Na, e.g., being mechanically much stiffer and with larger pore sizes. At this point, the energy storage community takes it for granted that K and Na require glass, not PP or PE. The problem with glass frits is that they are not employed in any standard battery manufacturing process and therefore may not be applicable outside a scientific laboratory bench-scale environment. Existing industrially scalable battery manufacturing processes rely on rolls of PP and PE separators, placing the onus on “Beyond Li” to follow suit. During battery cycling, ions shuttle between cathode and anode, passing through the pores of the electrolyte infiltrated separator. These separators remain excellent electrical insulators as long as metal dendrites do not breach them. Since the electrolyte is contained inside the separator pores, the flux of ions is not entirely uniform, and ion “crowding” occurs near the pore exit surfaces. During charging of a metal battery, this leads to regions at the anode where there is an enrichment of ions due to the direct contact of the separator pores with the anode. It also leads to ion depletion in regions where the dense separator material is in contact. Such anisotropic distribution of ions at the anode contributes to the non-uniform SEI geometry and phase content and has been associated with an inhomogeneous plating morphology during metal battery charging. Any protrusions at the metal-electrolyte interface may be seen as the starting point for dendrite growth. Commercial PP/PE separators have also been reported to display incomplete electrolyte wettability. Incomplete electrolyte wetting would further exacerbate inhomogeneous ion flux, further promoting dendrites. With ion battery anodes that are based on compacted powders, poor wetting of the separator may be compensated by the natural propensity for enhanced wetting on three-dimensional surfaces. With two-dimensional foil-based metal anodes, the problems associated with poor separator wetting may be more egregious.

While studies of the effect on battery performance as a result of separator modifications were done for Li and Na metal anodes, not much research was done to investigate a similar effect for K anodes. As discussed in several recent review articles, K metal anodes present a significantly greater challenge as compared to Li and Na in terms of controlling dendrites and stabilizing the SEI. Potassium metal is intrinsically more reactive than either Li or Na, with an SEI structure that is not readily stabilized in any non-aqueous electrolyte.

Therefore, to obtain competitive all-solid-state lithium-metal batteries without external pressure, the composition and ionic conductivity of the SEI layer must be optimized to suppress lithium dendrite nucleation as well as to improve the wettability of the solid electrolyte by a lithium-metal anode.

Thus, new approaches to providing for stable batteries having functional separators capable of stabilizing SEI in lithium, sodium, and potassium are needed. Electrochemical cells utilizing these new functional separators are also needed. These needs and other needs are at least partially satisfied by the present disclosure.

### SUMMARY

The present disclosure is directed to a multifunctional structure comprising: a first layer comprising a first polymer and having a first surface and a second surface, and a second layer comprising an inorganic-based material deposited on at least the first surface of the first layer, wherein the structure is an electrochemical cell separator.

In still further aspects, the disclosure is directed to a multifunctional structure comprising: a first layer comprising a first polymer and having a first surface and a second surface, and a second layer comprising an inorganic-based material deposited on at least the first surface of the first layer, wherein the inorganic-based material is ionically conducting and wherein the structure is an electrochemical cell separator.

In still further aspects, the disclosure is directed to a multifunctional structure comprising: a first layer comprising a first polymer and having a first surface and a second surface, and a second layer comprising an inorganic-based material deposited on at least the first surface of the first layer, wherein the inorganic-based material is electrically insulating and wherein the structure is an electrochemical cell separator.

In still further aspects, the disclosure is directed to a multifunctional structure comprising: a first layer comprising a first polymer and having a first surface and a second surface, and a second layer comprising an inorganic-based material deposited on at least the first surface of the first layer, wherein the inorganic-based material is semiconducting and wherein the structure is an electrochemical cell separator.

In still further aspects, disclosed herein is the multifunctional structure where the second layer further comprises a second polymer different from the first polymer.

In still further aspects, any of the disclosed herein multifunctional structures can comprise the inorganic-based material comprising at least one of salts, oxides, oxynitrides, sulfides, selenides, phosphides, carbides, nitrides, glass, ceramics, semiconductors, metal and/or alloys thereof, metalloids, intermetallics, or any combination thereof.

While in still further aspects, the first polymer comprises a polyolefin, polydopamine (PDA), polyimide (PI), polyetherimide (PEI), poly(ethylene terephthalate) (PET), poly(ethylene oxide) (PEO), polyacrylonitrile (PAN), poly(vinyl chloride) (PVC), poly(vinylidene fluoride) (PVDF), polyvinyl butyral (PVB), poly(methyl methacrylate) (PMMA), or any combination thereof.

In yet still, further aspects, the multifunctional structures disclosed herein can further comprise a third layer comprising an inorganic-based material deposited on the second surface of the first layer.

Further disclosed herein are aspects directed to an electrochemical cell comprising: at least one electrode; a separator comprising any of the disclosed herein multifunctional structures; and an electrolyte.

Still further disclosed is the electrochemical cell where the at least one electrode is an anode and/or cathode. In such exemplary aspects, the anode can comprise ions and/or metals of potassium, sodium, lithium, or a combination thereof. While in other aspects, the cathode can comprise a metal cathode or a composite cathode.

In yet further aspects, the electrolyte can comprise a salt and a non-aqueous solvent.

In some aspects, the disclosed herein electrochemical cell can exhibit substantially stable plating and stripping for at least about 200 cycles at about 0.5 mA cm⁻² and about 0.5 mAh cm⁻². While in other aspects, the disclosed herein electrochemical cell can exhibit a substantially stable plating and stripping for about 600 cycles or more at about 5 mA cm⁻² and about 1.0 mAh cm⁻². In still further aspects, the disclosed herein electrochemical cell is a battery.

Also disclosed herein is a method of making a multifunctional structure comprising depositing an inorganic-based material on at least a first surface of a first layer comprising a first polymer to form a second layer; and wherein the multifunction structure exhibits an ionic conductivity from about 0.1 mS/cm to about 1 S/cm.

Also disclosed here are methods of forming an electrochemical cell comprising: providing at least one electrode; providing any of the disclosed herein multifunctional structures; and providing an electrolyte.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIGS. 1A-1G depict analytical characterization results for the multifunctional separator AlF₃@PP. FIG. 1A-FIG. 1B show SEM images of the AlF₃@PP surface, taken at increasing magnifications. FIG. 1C shows an SEM image of the cross-section. FIG. 1D shows an EDX elemental mapping of the surface. FIGS. 1E and 1F show XPS spectra of core level F 1s and Al 2p for AlF₃@PP, unattached AlF₃ particles, and baseline PP. FIG. 1G shows a Raman spectrum of AlF₃@PP, AlF₃ particles, and PP.

FIG. 2 depicts photographs demonstrating the large-scale multifunctional separator of AlF₃@PP fabricated by the tape-casting method.

FIGS. 3A-3E show analysis of raw AlF₃ materials: FIG. 3A shows an XRD pattern. FIGS. 3B-3D show an SEM image with different magnifications. FIG. 3E shows EDXS elemental maps of the top surface, showing composite, Al, and F.

FIGS. 4A-4C show an XPS survey spectrum for raw AlF₃, baseline PP, and ALF₃@PP.

FIGS. 5A-5C depict SEM images: FIGS. 5A-5C show SEM top-view images of the baseline PP and FIG. 5C shows an SEM cross-sectional image of PP.

FIGS. 6A-6F depict a comparison of electrolyte wetting and ion transport properties of AlF₃@PP versus baseline PP separators. FIGS. 6A and 6B show contact angle measurements showing the electrolyte wetting behavior on AlF₃@PP (top row) and PP (bottom row). FIG. 6C shows top-down photographs showing electrolyte wetting behavior of AlF₃@PP vs. PP. FIG. 6D shows EIS Nyquist plots of symmetric stainless steel//stainless steel cells with different separators showing the ionic conductivity comparison. FIG. 6E shows EIS Nyquist plots of symmetric K//K cells with different separators showing the total cell resistance values R_{cell} for the calculation of ion transference number. FIG. 6F shows direct-current polarization measurements by using the same symmetric cells in FIG. 6E shows the ion transference number comparison.

FIGS. 7A-7B depict photographs of various aspects of the disclosure: FIG. 7A demonstrates the major enhancement of electrolyte wetting behavior of AlF₃@PP vs. the poor wetting achieved with the baseline PP (FIG. 7B).

FIGS. 8A-8L depict electrochemical performance comparison, AlF₃@PP vs. baseline PP, the current density, and capacity achieved per cycle labeled directly on panels. FIGS. 8A-8C show galvanostatic plating-striping profiles for half-cells. FIGS. 8D-8I show galvanostatic profiles for symmetric cells. FIGS. 8J-8L show galvanostatic rate results for symmetric cells. Panels FIGS. 8B-8C and FIGS. 8E, 8F, and FIGS. 8H, 8I, and FIGS. 8K, 8L are enlarged profiles of portions of FIG. 8A, FIG. 8D, FIG. 8G and FIG. 8J.

FIGS. 9A-9B show Individual plots of the same galvanostatic data presented in FIGS. 8E-8F, but with a magnified view highlighting the stable AlF₃@PP versus unstable baseline PP overpotential profiles of symmetric cells.

FIGS. 10A-10I show electrochemical analysis for half-cells and symmetric cells, AlF₃@PP vs. baseline PP, extracted from the 0.5 mA cm⁻² galvanostatic profiles. FIG. 10A shows a comparison of the first plating and stripping profiles for half cells. FIGS. 10B-10C show a comparison of plating and stripping overpotentials for half cells. FIG. 10D shows a comparison of the first plating and stripping profile for symmetric cells. FIGS. 10E-10F show a comparison of the plating and stripping overpotentials for symmetric cells. FIG. 10G shows a comparison of Coulombic efficiency (CE) of the half-cells. The CE value of symmetric cells was ˜99.99% due to the large K reservoir on each side. FIGS. 10H-10I show EIS Nyquist plots of half-cell AlF₃@PP and PP after the 1st, 10th, 50th, and 100th plating cycle.

FIGS. 11A-11J show top-down morphology analysis of the half-cell AlF₃@PP and baseline PP surfaces, and testing is done at 0.5 mA cm⁻². FIGS. 11A-11B show SEM images of AlF₃@PP in 100th plated condition, shown at increasing magnification. FIGS. 11C-11D show SEM images of AlF₃@PP in 100th stripped condition. FIGS. 11E-11H show the same analysis but performed for the baseline PP. FIG. 11I shows Light optical images of AlF₃@PP at 20th stripped condition. FIG. 11J shows the same analysis but performed for the baseline PP.

FIGS. 12A-12L show top-down SEM analysis of the half-cell AlF₃@PP and baseline PP surfaces at cycle 20, testing done at 0.5 mA cm⁻². FIGS. 12A-12C show AlF₃@PP in plated condition, shown at increasing magnification. FIGS. 12D-12F show AlF₃@PP in stripped condition. FIGS. 12G-12L show the same analysis but performed for the baseline PP.

FIGS. 13A-13D show SEM images and EDXS K, O, F, and S maps in the 20^{th} cycle. FIG. 13A shows AlF₃@PP in plated condition. FIG. 13B shows AlF₃@PP in stripped condition. FIG. 13C shows PP in plated condition. FIG. 13D shows PP in stripped condition.

FIGS. 14A-14D show SEM images and associated EDXS K, O, F, and S maps in the 100^{th} cycle. FIG. 14A shows AlF₃@PP in plated condition. FIG. 14B shows AlF₃@PP in stripped condition. FIG. 14C shows PP in plated condition. FIG. 14D shows PP in stripped condition.

FIGS. 15A-15F depict sputtering XPS spectra comparing the SEI for 20 cycle plated surfaces of AlF₃@PP versus baseline PP. FIGS. 15A-15B show AlF₃@PP fitted F 1s and Al 2p spectra with increasing etching time. FIGS. 15C-15D show the same analysis but for Al. FIG. 15E shows bar charts showing the atomic percentage concentrations of F element with increasing etching time. FIG. 15F shows bar charts showing the atomic percentage concentrations of Al element with increasing etching time.

FIGS. 16A-16C shows XPS spectra for 20 cycle plated anode surfaces of AlF₃@PP cell. FIG. 16A shows survey spectra. FIG. 16B shows fitted C 1s spectra. FIG. 16C shows fitted O 1s spectra.

FIGS. 17A-17C show XPS spectra for 20 cycle plated anode surfaces of PP cell. FIG. 17A shows survey spectra. FIG. 17B shows fitted C 1s spectra. FIG. 17C shows fitted O 1s spectra.

FIG. 18 shows atomic percentage concentrations of different elements with increasing sputtering etching time from XPS of samples after 20 cycles, analyzed in the plated state.

FIG. 19 shows bar charts showing the atomic percentage concentrations of O element with increasing sputtering etching time. Obtained from XPS analysis of samples after 20 cycles, analyzed in the plated state.

FIG. 20 shows a comparison of the band gap energy of materials.

FIGS. 21A-21H show electrochemical performance comparison of full cells with KFe—HCF cathode by using AlF₃@PP vs. baseline PP separator. Comparison at the current density of 50 mA/g: FIG. 21A shows cycling performance, FIG. 21B shows CE and FIG. 21C shows the charging-discharging curve of the 40th cycle. Comparison at the current density of 100 mA/g: FIG. 21D shows a cycling performance, FIG. 21E shows CE, FIG. 21F shows a comparison of whole charging-discharging profiles of AlF₃@PP vs. baseline PP. FIG. 21G shows a comparison of cycling performance at a large current density of 500 mA/g. FIG. 21H shows a comparison of rate performance.

FIGS. 22A-22B show analysis of as-synthesized KFe^{II}Fe^{III}(CN)₆. FIG. 22A shows an XRD pattern (PDF#: 73-0687). FIG. 22B shows a crystal structure.

FIGS. 23A-23C show the morphology of KFe^{II}Fe^{III}(CN)₆ materials. FIGS. 23A-23B show an SEM image with different magnifications. FIG. 23C shows EDXS elemental maps of the top surface, showing composite, K, Fe, and C.

FIG. 24 shows a schematic of the fabrication of a multifunctional separator consisting of polypropylene that is double-coated with a reactive micro-scale AlF₃ layer, denoted as AlF₃@PP

FIG. 25 shows a schematic illustration of the role of AlF₃@PP in stabilizing the plating and stripping reactions, preventing dendrite growth and dead metal. The AlF₃@PP possesses improved electrolyte wetting and uptake, improved ion conductivity, and increased ion transference numbers. It also partially reacts to form an artificial SEI. Top and bottom, AlF₃@PP versus baseline PP.

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a functional additive” includes two or more such functional additives, reference to “a battery” includes two or more such batteries and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms that shall be defined herein.

For the terms “for example” and “such as,” and grammatical equivalences thereof, the phrase “and without limitation” is understood to follow unless explicitly stated otherwise.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell,” refers to a reference composition, article, or an electrochemical cell comprising substantially identical components and wherein an inventive component is substituted with a common in the art component.

The symbol “□” depicts a vacancy.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Multifunctional Structure

As disclosed above, the current disclosure is directed to a first layer comprising a first polymer and having a first surface and a second surface, and a second layer comprising an inorganic-based material deposited on at least the first surface of the first layer, wherein the structure is an electrochemical cell separator. Yet in still further aspects, disclosed is a multifunctional structure comprising: a first layer comprising a first polymer and having a first surface and a second surface, and a second layer comprising an inorganic-based material deposited on at least the first surface of the first layer, wherein the inorganic-based material is ionically conducting and wherein the structure is an electrochemical cell separator. In still further aspects, disclosed is a multifunctional structure comprising: a first layer comprising a first polymer and having a first surface and a second surface, and a second layer comprising an inorganic-based material deposited on at least the first surface of the first layer, wherein the inorganic-based material is electrically insulating and wherein the structure is an electrochemical cell separator. While in still further aspects, disclosed is a multifunctional structure comprising: a first layer comprising a first polymer and having a first surface and a second surface, and a second layer comprising an inorganic-based material deposited on at least the first surface of the first layer, wherein the inorganic-based material is semiconducting and wherein the structure is an electrochemical cell separator.

In certain aspects, the second layer comprising the inorganic-based material can further comprise a second polymer different from the first polymer in the first layer.

The disclosed herein inorganic-based materials can comprise at least one of salts, oxides, oxynitrides, sulfides, selenides, phosphides, carbides, nitrides, glass, ceramics, semiconductors, metal and/or alloys thereof, metalloids, intermetallics, or any combination thereof.

In some aspects, if the salts are present, such salts can comprise one or more of fluorides, chlorides, chlorates, perchlorates, iodates, tetrachloroaluminates, tetrochloroborates, bromates, iodides, phosphates, nitrates, silicates, or any combination thereof. Yet, in still further aspects, the inorganic-based material can also comprise tellurium, selenium, sulfur, or any combination thereof. Yet, in still further aspects, tellurium, selenium, and sulfur can be present in combination with any of the other disclosed salts. Yet, in other aspects, metal and/or alloys thereof can comprise aluminum, magnesium, calcium, potassium, barium, zinc, tin, yttrium, zirconium, lanthanum, gadolinium, scandium, strontium, sodium, lithium, germanium, silicon, aluminum, or any combination thereof.

In still further aspects, the inorganic-based material comprises one or more of AlF₃, Al₂O₃, TiO₂, SiO₂, BaTiO₃, fluorite Gd_{0.1}Ce_{0.9}O_{1.95}, perovskite La_{0.8}Sr_{0.2}Ga_{0.8}Mg_{0.2}O_{2.55}, a metal-organic framework, graphite oxide, graphene oxide, polyhedral oligomeric silsesquioxanes, Li₂CO₃, Li₃PO₄, BN, Li₃S₄, Li₂O, montmorillonite, zeolite, Li₃N, garnet Li₇La₃Zr₂O₁₂ and Li_{6.4}La₃Zr_{1.4}Ta_{0.6}O₁₂, perovskite Li₃ₓLa_{2/3-x}□_{1/3-2x}TiO₃, where □ is a vacancy and 0.06<x<0.14, anti-perovskite Li₃OX, Li₂OHX, wherein X is Cl, Br, or I, NASICONLi₁₊ₓM′ₓM″₂₋ₓ(PO₄)₃, wherein M′ is Al, Sc, or Y, and M″ is Ti or Ge, Li_{1+x+y}Ti₂₋ₓAlₓSi_{y}(PO₄)_{3-y}, halide Li₃X′Cl₆, wherein X′is Y, In, Zr, Er, or Al, binary sulfide Li₂S—P₂S₅ or Li₂S—MS₂, wherein M is Ge, Si, or Sn, argyrodite Li₆PS₅X, where X is F, Cl, Br, or I, thio-LISICON Li₁₀GeP₂S₁₂, AlN, SiC, Si₃N₄, Sr₂Ce₂Ti₅O₁₆, ZrSiO₄, CaSiO₃, SiO₂, BeO, CeO₂, ZnO, MgO, MgCl, bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (LiI), lithium chlorate (LiClO₃), LiBrO₃, LiIO₃, Lithium trifluoromethanesulfonate (LiTF), Lithium difluoro(oxalato)borate (LiODFB), or any combination thereof.

In still further aspects, if the second polymer is present in the second layer, such a polymer can be an ion-conducting polymer. It is understood that in some aspects, the second polymer is different from the first polymer. Yet, in still further aspects, the second polymer is the same as the first polymer. In certain aspects, the second polymer can be selected from polyacetylene, polyaniline, polypyrrole, poly(fluorene), polyphenylene, polypyrene, polyazulene, polynaphthalene, polycarbazoles, polyindole, polyazepine, polythiophene, poly (para-phenylene), poly(phenylenevinylene), polyfuran, poly(3,4-ethylenedioxythiophene):poly(styrenesulfonate) (PEDOT:PSS), or any combination thereof.

In still further aspects, the first polymer can comprise a polyolefin, polydopamine (PDA), polyimide (PI), polyetherimide (PEI), poly(ethylene terephthalate) (PET), poly(ethylene oxide) (PEO), polyacrylonitrile (PAN), poly(vinyl chloride) (PVC), poly(vinylidene fluoride) (PVDF), polyvinyl butyral (PVB), poly(methyl methacrylate) (PMMA), or any combination thereof. In still further aspects, the polyolefin can comprise polyethylene, polypropylene, or a combination thereof

It is understood that any of these materials can be prepared by any known in the art methods. For example, in some aspects, the inorganic-based materials can be obtained by a solid-state reaction or by a sol-gel or a liquid phase reaction method.

Still further disclosed herein are aspects where the multifunctional structure further comprises comprising a third layer comprising an inorganic-based material deposited on the second surface of the first layer. It is understood that this third layer can comprise any of the disclosed above inorganic-based materials.

In certain aspects, the second layer deposited on the first surface of the first layer comprises a composition that is substantially similar to a composition of the third layer deposited on the second surface of the first layer. While in other aspects, the second layer deposited on the first surface of the first layer comprises a composition that is substantially different from a composition of the third layer deposited on the second surface of the first layer.

Yet, in other aspects, the second layer or the third layer can comprise a plurality of particles. In still further aspects, the plurality of particles can be a plurality of nanoparticles, a plurality of microparticles, or a combination thereof. In such exemplary and unlimiting aspects, the plurality of particles can have an average size of about 50 nm to about 50 μm, including exemplary values of about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1 μm, about 1.2 μm, about 1.5 μm, about 1.8 μm, about 2.0 μm, about 2.2 μm, about 2.5 μm, about 2.8 μm, about 3.0 μm, about 3.2 μm, about 3.5 μm, about 3.8 μm, about 4.0 μm, about 4.2 μm, about 4.5 μm, about 4.8 μm, about 5 μm, about 5.5 μm, about 6 μm, about 6.5 μm, about 7 μm, about 7.5 μm, about 8 μm, about 8.5 μm, about 9 μm, about 9.5 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about25 μm, about26 μm, about27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about44 μm, about 45 μm, about 46 μm, about 47 μm, about 48 μm, and about 49 μm.

In some aspects, the plurality of particles can have an average size of less than about 50 nm, less than about 40 nm, less than about 30 nm, less than about 20 nm, or even less than about 10 nm. While in yet other aspects, the plurality of particles can have an average size greater than about 20 μm, greater than about 25 μm, greater than about 30 μm, greater than about 35 μm, greater than about 40 μm, greater than about 45 μm, and even greater than about 50 μm. In certain aspects, the size of the particles can be controlled by any known in the art methods, for example, and without limitations, it can be controlled by ball-milling methods.

In still further aspects, the second and the third layer, if present, have a thickness from about 1 μm to about 50 μm, including exemplary values of about 2 μm, about 5 μm, about 8 μm, about 10 μm, about 15 μm, about 20 μm, about 25 μm, about 30 μm, about 35 μm, about 40 μm, and about 45 μm.

In still further aspects, the thickness of the second layer deposited on the first surface of the first layer can be the same or different from the thickness of the third deposited on the second surface of the first layer.

Also disclosed herein are aspects, wherein the second layer and the third layer, if present, have a mass loading of about 0.5 mg cm⁻² to about 2 mg cm⁻², including exemplary values of about 0.6 mg cm⁻², about 0.7 mg cm⁻², about 0.8 mg cm⁻², about 0.9 mg cm⁻², about 1.0 mg cm⁻², about 1.1 mg cm⁻², about 1.2 mg cm⁻², about 1.3 mg cm⁻², about 1.4 mg cm⁻², about 1.5 mg cm⁻², about 1.6 mg cm⁻², about 1.7 mg cm⁻², about 1.8 mg cm⁻², and about 1.9 mg cm⁻².

In still further aspects, it is understood that the mass loading of the inorganic-based material on the first surface of the first layer can be the same as the mass loading of the inorganic-based material on the second surface of the first layer. While in other aspects, the mass loading of the inorganic-based material on the first surface of the first layer can be different from the mass loading of the inorganic-based material on the second surface of the first layer. In such aspects, the mass loading value can be any value between any two foregoing values.

In some aspects, the second layer and the third layer, if present, can have a roughness from about 50 nm rms to about 5 μm rms, including exemplary values of about 100 nm, about 150 nm, about 200 nm, about 250 nm, about 300 nm, about 350nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1 μm, about 1.2 μm, about 1.5 μm, about 1.8 μm, about 2.0 μm, about 2.2 μm, about 2.5 μm, about 2.8 μm, about 3.0 μm, about 3.2 μm, about 3.5 μm, about 3.8 μm, about 4.0 μm, about 4.2 μm, about 4.5 μm, and about 4.8 μm rms.

Similarly, disclosed are aspects where the roughness of the second layer deposited on the first surface of the first layer can be the same or different from the roughness of the third layer deposited on the second surface of the first layer.

In still further aspects, it is understood that the particles present in the second layer or the third layer, if present, can have any possible shape. In some aspects, the plurality of nanoparticles or microparticles have a star-like shape, a spheric shape, a non-regular shape, fibrous shape, rod shape, cubic, oval, prism, helical, pillar, or any combination thereof.

In still further aspects, the multifunctional structure of the current disclose can exhibit substantial wettability when exposed to an electrolyte. In such aspects, the electrolyte can at least partially wet the multifunctional structure. While in another aspect, the electrolyte can substantially wet the multifunctional structure.

In still other aspects, the multifunctional structure can exhibit a contact angel from 0° to about 50°, including exemplary values of about 5°, about 10°, about 15°, about 20°, about 25°, about 30°, about 35°, about 40°, and about 45°.

In such aspects, where the multifunctional structure is exposed to the electrolyte, the electrolyte can comprise a salt and a non-aqueous solvent. In some exemplary aspects, the salt can comprise potassium, sodium, or a lithium salt of bis(fluorosulfonyl) imide, trifluoromethanesulfonate, bis(trifluoromethane)sulfonimide, difluoro(oxalato)borate, perchlorate, tetrafluoroborate, hexafluorophosphate, hexafluroarsenate, aluminum tetrachloride, boron tetrachloride iodide, chlorate, borate, iodate, or a combination thereof. While in other aspects, the non-aqueous electrolyte can comprise dioxane, ethylene carbonate, dimethyl carbonate, diethyl carbonate, ethyl methyl carbonate, polyoxylene, fluoroethylene carbonate, ethylene carbonate, N-methyl acetamide, N-Methyl-2-pyrrolidone, acetonitrile, symmetric sulfone, sulfolane, polyethylene glycol, 1,3-dioxolane, glymes, siloxane, ethylene oxide grafted sulfolane, toluene, dimethylbenzene, dimethylformamide, dimethyl sulfoxide, tetrahydrofuran, or a combination thereof.

In some aspects, the multifunctional structure disclosed herein can be used in an electrochemical cell. In such exemplary aspects, the inorganic-based material is substantially non-reactive when used in the electrochemical cell. While in other exemplary aspects, the inorganic-based material is at least partially reactive when used in the electrochemical cell.

In still further aspects, where the inorganic-based material is at least partially reactive when used in the electrochemical cell, a reaction product of the inorganic-based material is configured to form at least one further layer disposed on the second layer and/or the third layer, if present. In such exemplary aspects, the at least one further layer is a solid-electrolyte interphase (SEI) layer.

In still further aspects, the multifunctional structure can exhibit an ion transference number at least about 20% greater, at least about 30% greater, at least about 40% greater, at least about 50% greater, at least about 60% greater, at least about 70% greater, at least about 80% greater, at least about 90% greater, or at least about 100% greater than an ion transference number exhibited by a substantially identical reference multifunctional structure in the absence of the second layer and/or third layer, if present, wherein the ion transference number is an ion transference number of K, Na, or Li.

In still further aspects, the multifunctional structure can exhibit an ion transference number greater than about 0.5, greater than about 0.6, greater than about 0.7, or greater than about 0.8, wherein the ion transference number is an ion transference number of K, Na, or Li.

In still further aspects, the multifunctional structure can exhibit an ionic conductivity for K, N, or Li from about 0.1 mS/cm to about 1 S/cm, including exemplary values of about 0.5 mS/cm, about 1 mS/cm, about 1.5 mS/cm, about 2 mS/cm, about 2.5 mS/cm, about 3.0 mS/cm, about 3.5 mS/cm, about 4.0 mS/cm, about 4.5 mS/cm, about 5 mS/cm, about 5.5 mS/cm, about 6 mS/cm, about 6.5 mS/cm, about 7 mS/cm, about 7.5 mS/cm, about 8.0 mS/cm, about 8.5 mS/cm, about 9.0 mS/cm, about 9.5 mS/cm, about 10 mS/cm, about 15 mS/cm, about 20 mS/cm, about 25 mS/cm, about 30 mS/cm, about 35 mS/cm, about 40 mS/cm, about 45 mS/cm, about 50 mS/cm, about 55 mS/cm, about 60 mS/cm, about 65 mS/cm, about 70 mS/cm, about 75 mS/cm, about 80 mS/cm, about 85 mS/cm, about 90 mS/cm, about 95 mS/cm, about 100 mS/cm, about 200 mS/cm, about 300 mS/cm, about 400 mS/cm, about 500 mS/cm, about 600 mS/cm, about 700 mS/cm, about 800 mS/cm, and about 900 mS/cm.

In still further aspects, the second layer deposited on the first surface of the first layer is configured to face an anode, and the third layer deposited on the second surface of the first layer, if present, is configured to face a cathode when placed into an electrochemical cell.

While in yet other aspects, the inorganic-based material can be deposited by methods known in the art. For example, the inorganic-based material can be deposited by magnetron sputtering, wet and dry chemistry, chemical and electrochemical deposition, spin coating, spray drying, tape casting, screen printing, thermal and hydrothermal method, or any combination thereof.

### Electrochemical Cell

Also disclosed herein is an electrochemical cell comprising: at least one electrode, a separator comprising any of the disclosed above multifunctional structures, and an electrolyte.

In such aspects, the at least one electrode can be an anode or a cathode. In yet other aspects, the electrochemical cell can comprise both anode and cathode. In still further aspects, the electrochemical cell disclosed herein is a battery. In such exemplary aspects, the battery can be a metal batter or ion-metal battery.

In certain aspects, the battery can be primary. Yet, in other aspects, the battery can be a secondary battery.

In aspects disclosed herein, the anode can comprise ions and/or metals of potassium, sodium, lithium, or a combination thereof. For example, in some aspects, the anode is a metal anode comprising Li, K, or Na, or combinations and alloys thereof. In yet still further aspects, the metal anode comprises K. In yet still further aspects, the metal anode comprises Li. In yet still further aspects, the metal anode comprises Na. In yet still further aspects, the anode is an ion-metal anode. For example, potassium-ion anode, lithium-ion anode, sodium-ion anode, or a combination thereof.

In still further aspects, the electrolyte can comprise any electrolytes described above. For example, the electrolyte can comprise a salt and a non-aqueous solvent. In some aspects, the salt comprises a potassium, sodium, or a lithium salt of bis(fluorosulfonyl) imide, trifluoromethanesulfonate, bis(trifluoromethane)sulfonimide, difluoro(oxalato)borate, perchlorate, tetrafluoroborate, hexafluorophosphate, hexafluroarsenate, aluminum tetrachloride, boron tetrachloride iodide, chlorate, borate, iodate, or a combination thereof. While in other aspects, the non-aqueous solvent comprises dioxane, ethylene carbonate, dimethyl carbonate, diethyl carbonate, ethyl methyl carbonate, polyoxylene, fluoroethylene carbonate, ethylene carbonate, N-methyl acetamide, acetonitrile, symmetric sulfone, sulfolane, polyethylene glycol, 1,3-dioxolane, glymes, siloxane, ethylene oxide grafted sulfolane, or a combination thereof.

The electrochemical cell of the present disclosure can further comprise a cathode. It is understood that any known in the art cathode materials that can be useful for the desired purpose can be utilized. In some aspects, the cathode can be a metal cathode or composite cathode.

If the metal cathode is used, such an electrochemical cell can be a symmetrical electrochemical cell. In such an exemplary aspect, when the electrochemical cell is symmetrical, both anode and cathode comprise the same material, for example, and without limitation, it can comprise Li or K or Na, or a combination thereof.

In still further aspects, the cathode material can be a composite material. In such aspects, if the electrochemical cell is a lithium electrochemical cell, any known in the art cathode materials that are useful in the Li cell can be utilized. If the electrochemical cell is K or Na cell, any known in the art cathode materials that are useful in Na or K cells can be utilized.

In some aspects, the cathode can also comprise copper, carbon, graphite, sodium, potassium, lithium, layered oxides, spinels, olivines, or any combination thereof.

In yet still further aspects, the cathode can comprise a LiFePO₄ composite cathode, a LiNi_{0.8}CO_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.1}O₂ composite cathode. In still further aspects, the cathode can comprise KFe^{II}Fe^{III}(CN)6, NaFe^{II}Fe^{III}(CN)₆, Na₃V₂(PO₄)₃, LiFePO₄, Li(NiCoMn)O₂, or any combination thereof. In yet still further aspects, the cathode material can also comprise a poly(ethylene oxide), cellulose, carboxymethylcellulose (CMC), a polytetrafluoroethylene (PTFE), styrene-butadiene rubber (SBR), or a polyvinylidene fluoride binder.

In still further aspects, the electrochemical cell as disclosed herein exhibits a substantially stable plating and stripping for at least about 200 cycles, at least about 300 cycles, at least about 400 cycles, at least about 500 cycles, at least about 600 cycles, at least about 700 cycles, at least about 800 cycles, at least about 900 cycles, or at least about 1000 cycles at about 0.5 mA cm⁻² and bout 0.5 mAh cm⁻².

In still further aspects, the electrochemical cell as disclosed herein exhibits a substantially stable plating and stripping for at least about 200 cycles, at least about 300 cycles, at least about 400 cycles, at least about 500 cycles, at least about 600 cycles, at least about 700 cycles, at least about 800 cycles, at least about 900 cycles, or at least about 1000 cycles at about 5 mA cm⁻² and bout 1 mAh cm⁻².

In still further aspects, the electrochemical cell, as disclosed herein, can provide a capacity greater than about 90 mAh/g, greater than about 100 mAh/g, greater than about 110 mAh/g, greater than about 120 mAh/g, greater than about 130 mAh/g, greater than about 140 mAh/g, greater than about 150 mAh/g after about 100 cycles at a current density of about 100 mA/g.

In still further aspects, the electrochemical cell, as disclosed herein, exhibits a capacity retention greater than about 90%, greater than about 91%, greater than about 92%, greater than about 93%, greater than about 94%, greater than about 95%, greater than about 96%, greater than about 97%, greater than about 98%, or greater than about 99% for at least about 100 cycles, at least about 200 cycles, at least about 300 cycles, at least about 400 cycles, or at least about 500 cycles.

In yet still further aspects, the cell can exhibit a substantial discharge capacity retention of no less than about 99.9%, no less than about 99%, no less than about 95%, no less than about 90%, no less than about 85%, no less than about 80%, no less than about 75%, or no less than about 70% after at least about 100 stripping/plating cycles, at least about 200 cycles, at least about 300 cycles, at least about 400 cycles, or at least about 500 cycles.

As disclosed above, if the inorganic-based material is at least partially reactive, it can react with the electrolyte, for example, and to form a solid electrolyte interphase (SEI) layer. In still further aspects, and as disclosed herein, a solid electrolyte interphase (SEI) layer can be formed in-situ during the electrochemical cell operation. This SEI layer can suppress the nucleation of lithium, potassium, and/or sodium dendrites and increase the critical current density. In certain aspects, the SEI layer can comprise at least one of halide or fluoride, depending on the electrolyte composition.

In still further aspects, the separator is substantially dendrite-free after a plating process as compared to a substantially identical reference electrochemical cell having a substantially identical separator in the absence of the inorganic-based material after a substantially identical plating process.

In yet still further aspects, the separator is substantially smooth after a stripping process as compared to a substantially identical reference electrochemical cell having a substantially identical separator in the absence of the inorganic-based material after a substantially identical stripping process.

In still further aspects, the SEI layer that is formed in-situ can have a thickness from about 10 nm to about 100 nm, including exemplary values of about 20 nm, about 30 nm, about 40 nm, about 50 nm, about 60 nm, about 70 nm, about 80 nm, and about 90 nm. It is understood, however, that the SEI can have any thickness that falls between any foregoing values.

In still further aspects, the electrochemical cell is configured to operate in a temperature range from about 20° C. up to about 60° C., including exemplary values of about 25° C., about 30° C., about 35° C., about 40° C., about 45° C., about 50°° C., and about 55° C. It is understood that a time window for the cell operation can be dependent on the operating conditions, such as operating current density and areal capacity.

By way of example, electrochemical cells of the present disclosure may be used in portable batteries, including those in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries, containing at least about 10, at least about 100, at least about 500, between 10 and 10,000, between 100 and 10,000, between 1,000 and 10,000, between 10 and 1000, between 100 and 1,000, or between 500 and 1,000 electrochemical cells of the present disclosure. Cells in multi-cell batteries may be arranged in parallel or in series.

### Methods

Further disclosed herein are methods making a multifunctional structure comprising depositing an inorganic-based material on at least a first surface of a first layer comprising a first polymer to form a second layer, and wherein the multifunction structure exhibits an ionic conductivity from about 0.1 mS/cm to about 1 S/cm, including exemplary values of about 0.2 mS/cm, about 0.3 mS/cm, about 0.4 mS/cm, about 0.5 mS/cm, about 0.6 mS/cm, about 0.7 mS/cm, about 0.8 mS/cm, about 0.9 mS/cm, about 10 mS/cm, about 15 mS/cm, about 20 mS/cm, about 25 mS/cm, about 30 mS/cm, about 35 mS/cm, about 40 mS/cm, about 45 mS/cm, about 50 mS/cm, about 55 mS/cm, about 60 mS/cm, about 65 mS/cm, about 70 mS/cm, about 75 mS/cm, about 80 mS/cm, about 85 mS/cm, about 90 mS/cm, about 95 mS/cm, about 100 mS/cm, about 200 mS/cm, about 300 mS/cm, about 400 mS/cm, about 500 mS/cm, about 600 mS/cm, about 700 mS/cm, about 800 mS/cm, and about 900 mS/cm.

In still further aspects, the inorganic-based material can be ionically conducting. In yet other aspects, the inorganic-based material can be electrically insulating. In still further aspects, the inorganic-based material can be ionically conducting and electrically insulating. In still further aspects, the inorganic-based material can be semiconducting.

It is understood that any known in the art method of depositing can be used. For example, and without limitations, the step of depositing can comprise a magnetron sputtering, wet and dry chemistry, chemical and electrochemical deposition, spin coating, spray drying, tape casting, screen printing, thermal and hydrothermal method, or any combination thereof.

In yet other aspects, the first layer can be provided, for example, as a continuous tape. While in other aspects, the first layer can be deposited on a substrate.

In still further aspects, the method can further comprise depositing an inorganic-based material on a second surface of the first layer to form a third layer. In such exemplary and unlimiting aspects, the depositing of the inorganic-based material on the first surface of the first layer and the second surface of the first layer is conducted simultaneously or in a sequence.

In still further aspects, the step of depositing of the inorganic-based material on the first surface and/or the second surface of the first layer is continuous.

Any of the disclosed herein inorganic-based materials can be used. In certain aspects, the second layer (and the third layer if present) can comprise a second polymer. Any of the disclosed above second polymers can be used.

In yet other aspects, any of the disclosed herein first polymers in the first layer, if present first layers, can be utilized.

Also disclosed herein is a method of forming an electrochemical cell comprising: providing at least one electrode; any of the disclosed herein multifunctional systems and any of disclosed herein electrolytes. The at least one electrode can comprise any of the disclosed above electrodes.

By way of non-limiting illustration, examples of certain aspects of the present disclosure are given below.

### Examples

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

### Materials

Potassium fluoride (AlF₃, 99.9%), potassium (K, 99.5%) metal, potassium ferricyanide(III) (K₃Fe(CN)₆, 99%), iron(II) chloride tetrahydrate (FeCl₂·4H₂O, 98%), 1,2-dimethoxyethane (DME, 99.5%) and N-Methyl-2-Pyrrolidone (NMP, 99.5%) were purchased from Sigma-Aldrich. Potassium bis(fluoroslufonyl)imide (KFSI, >99.9%, water content <50 ppm) were purchased from Suzhou Fluolyte Co., Ltd. Commercial Celgard 2400 polypropylene (PP) separator was purchased from Celgard Corporation. Cu foil and polyvinylidene fluoride (PVDF) were purchased from MTI Corporation.

### Fabrication of the Multifunctional AlF₃@PP Separator

AlF₃ and PVDF with a weight of 95:5 were first mixed in NMP solvent to obtain a slurry. Then, a single-side-coated AlF₃@PP was fabricated by tape-casting the slurry on a PP separator using an automated tape casting machine (MSK-AFA-III, MTI Corporation). This was followed by vacuum drying at 60° C. for 1 hour to remove the solvent. For obtaining the targeted double-sided coated AlF₃@PP, the tape casting process was repeated again on the other side of the PP separator. This followed a final vacuum drying step at 85° C. for 12 hours.

### Synthesis of the Potassium Hexacyanoferrate(III) Cathodes

Potassium hexacyanoferrate(III) KFe^{II}Fe^{III}(CN)₆, one kind of Prussian blue, was synthesized by a modified hydrothermal method. First, 1.646 g of K₃Fe(CN)₆ was dissolved in 60 ml deionized water filled in an 80 ml Teflon-lined stainless steel autoclave, with magnetic stirring of 30 min at room temperature. Then, 0.99 g of FeCl₂·4H₂O was added into the solution and stirred for another 30 min at room temperature. The Teflon-lined stainless steel autoclave with the homogeneous mixing solution was then heated to 80° C. for 24 h. The products were collected by centrifugation at 10,000 rpm and washed several times with deionized water and ethanol. KFe^{II}Fe^{III}(CN)₆ nanoparticles were finally obtained after vacuum drying at 60° C. for 12 h with keeping the vacuum pump working.

### Electrochemical Analysis

Electrochemical tests were performed using 2032-type coin cells. The electrolyte was 4M KFSI in DME without any additives. To standardize the measurement, a fixed amount (80 μL) of electrolyte was used in each coin cell. The coin cells were assembled in an Ar-filled glove box with <0.1 ppm H₂O and O₂ levels. Half-cells comprised a working electrode (Cu foil) opposing a standard K metal foil. The half-cells first underwent 5 “formation cycles” between 0.01 V and 1 V at 50 μA cm⁻², which cleaned the surfaces from any residual impurities and stabilized the SEI layer without plating K metal. During testing at various current densities, a capacity of 0.5 mAh cm⁻² was plated at each cycle. For the stripping cycle, the current density was the same as that of the plating cycle. Since the CE of half-cells was not 100%, the stripping cut-off condition was set at an anodic voltage of 1 V. Symmetric cells consisted of two standard K metal foils. The symmetric cells were electrochemically tested, with the plating and stripping times being symmetric.

For full K metal full batteries, KFe^{II}Fe^{III}(CN)₆ (80 wt %), acetylene black (10 wt %), and PVDF (10 wt %) were uniformly dispersed in NMP. The resultant slurry was pasted onto an Al foil, followed by vacuum drying at 120° C. for 12 h. KFe^{II}Fe^{III}(CN)₆ cathodes with an active mass loading of ˜2.1 mg cm⁻² were assembled with K foil anodes into CR2032-type coin cells inside an Ar-filled glovebox. The electrolyte employed was 0.8M potassium hexafluorophosphate (KPF₆) dissolved in ethylene carbonate (EC) and diethyl carbonate (DEC). AlF₃@PP and baseline PP were used as separators. The charge-discharge tests were carried out at various current densities in the voltage range of 2.0 to 4.5 V. Cycling tests were performed on a LAND CT2001A battery tester, while electroanalytical tests were performed on a Princeton PARSTAT MC electrochemical workstation.

The ionic conductivity of separators was determined by sandwiching separators between two stainless steel blocking electrodes (diameter: 1.6 cm). Electrochemical impedance spectroscopy (EIS) was collected using an electrochemical workstation at open circuit potential, with a constant perturbation amplitude of 5 mV in the frequency of 0.01-100 KHz. The ionic conductivity of the separators was calculated using the EIS according to Equation S1:

$$σ = L / ( {R}_{b} \times A ) \qquad ( Equation S 1 )$$

where σ is the K⁺ conductivity (mS cm⁻¹), L is the thickness of the separator (cm), R_{b} is the bulk resistance (Ω) obtained from the intercept of the Nyquist plot with the real axis, and A is the area of the stainless steel electrode (cm²).

Ion transference numbers were obtained from alternating-current (AC) impedance and direct-current (DC) polarization measurements performed on symmetric K//K cells. AC impedance test was used to obtain the cell total resistance R_{cell} after a rest of 24 h. It was conducted at a scanning frequency range of 0.01-100 kHz at open circuit potential with an amplitude of 5 mV. DC polarization measurements were also carried out with a voltage bias of 10 mV to obtain stable /_{DC} and derive R_{DC} (R_{DC}=_{VDC}//_{DC}). The K ion transference number was calculated by the equation t_{K}=R_{cell}/R_{DC}.

### Characterization

Scanning electron microscopy (SEM) measurements were conducted using a field emission SEM (Hitachi 4800) at 5 kV. Raman spectra were acquired with an Alpha 300 confocal Raman microscope (WITec, GmbH) using a solid-state 532 nm excitation laser. X-ray Photoelectron Spectroscopy results were collected using an XPS system (Kratos, Axis Ultra DLD) equipped with Mg Kα as the excitation source. Electrolyte wettability was studied using an FTA200 contact angle goniometer.

For post-cycled characterization, the cells were disassembled in the Ar-filled glovebox. The working electrodes were extracted out and washed in DME to remove the residual electrolyte and soluble SEI species. Sealed containers specifically designed for SEM and XPS characterization were employed for sample transfer from the glove box to the analytical tools. For the optical observation, an optical microscope (Zeiss Axioscope 2 MAT) was used to observe the surface of stripped samples that were sealed in Ziplock bags.

### Results and Discussion

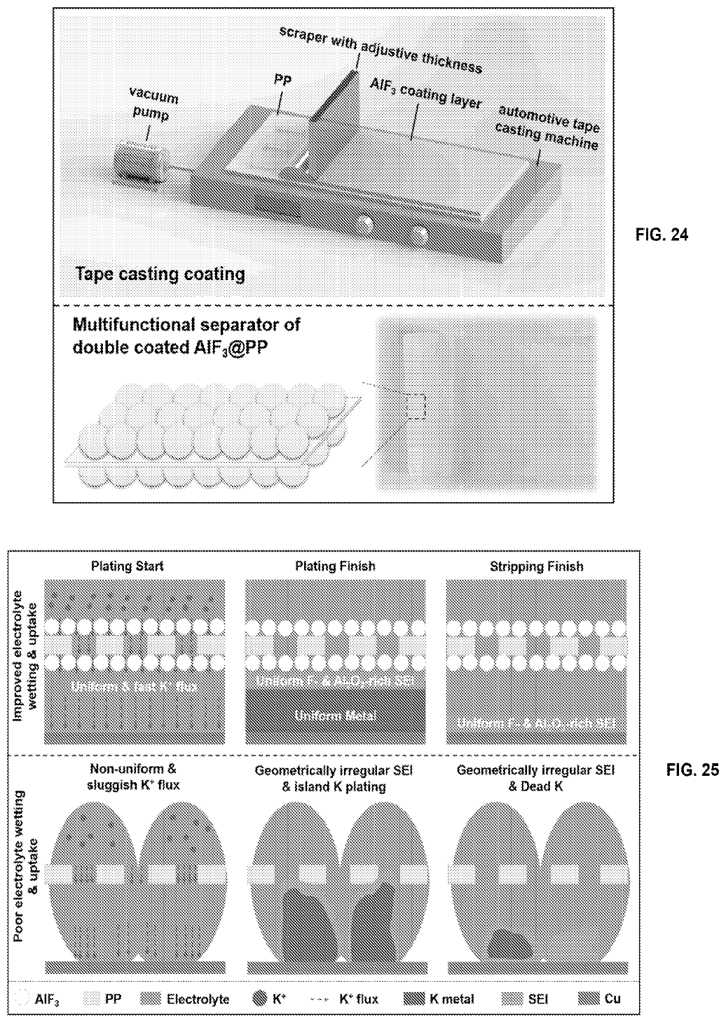

The multifunctional separator consisting of polypropylene PP that is double-coated with a reactive micro-scale AlF₃ layer (denoted as AlF₃@PP) was fabricated by an industry-compatible tape casting method, as shown in FIG. 24. Employing an automated tape casting machine, a layer of AlF₃ was coated on one side of the PP separator. After fast vacuum drying to remove the solvent, the other side of the separator was identically coated by a layer of AlF₃. After further vacuum drying, the final AlF₃@PP architecture was obtained. The mass loading of AlF₃@PP is 1.1 mg cm⁻² on each side, and the coating layer thickness is ˜30 μm on each side.

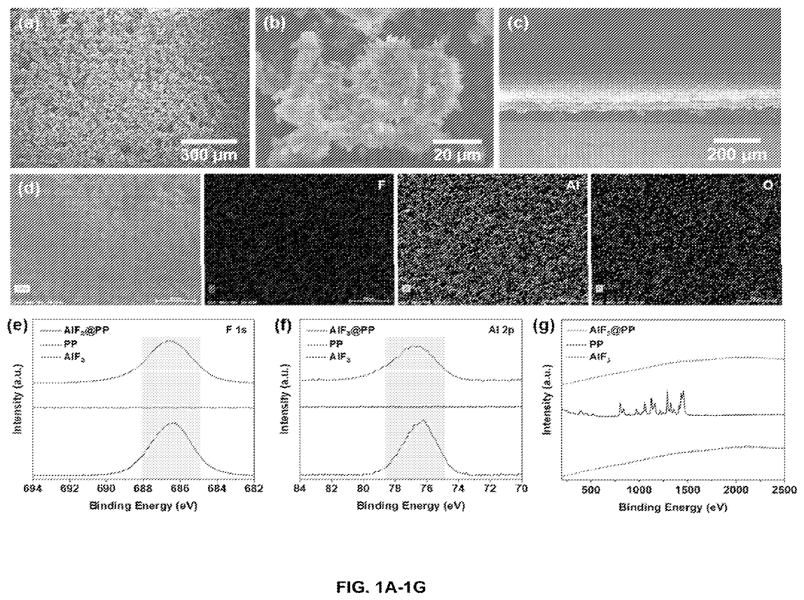

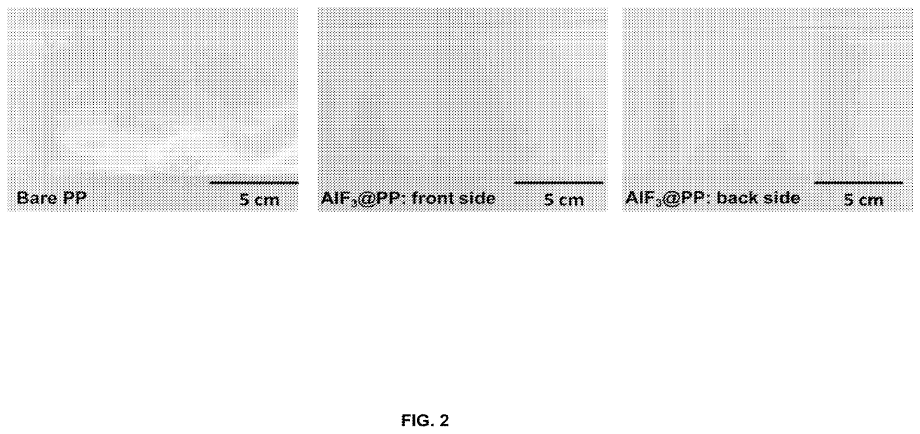

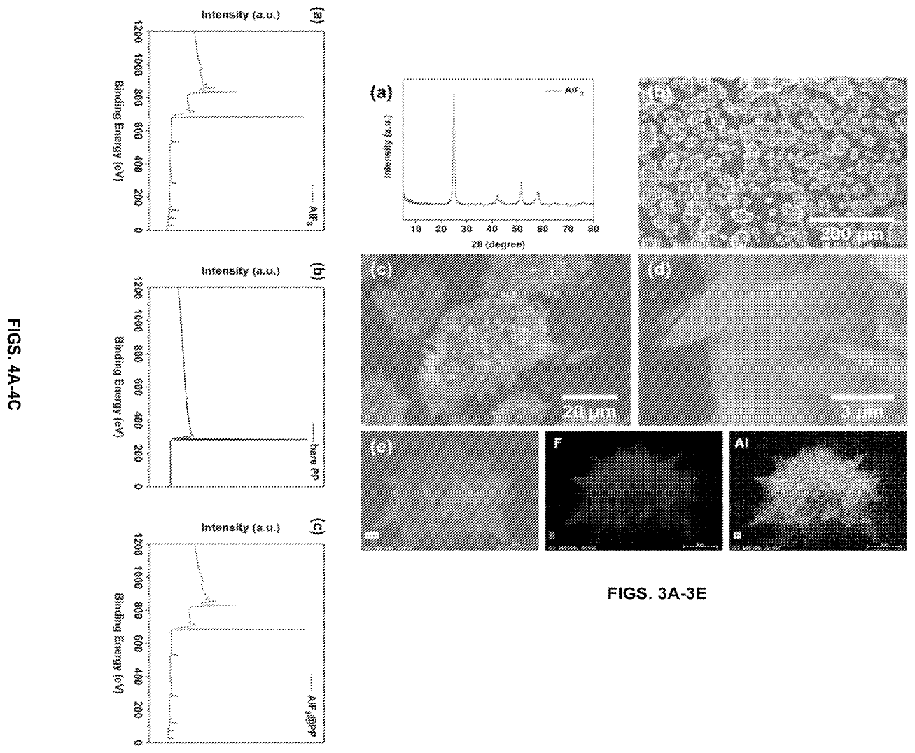

FIG. 1 provides characterization results for the multifunctional AlF₃@PP separator. FIG. 2 shows photographs highlighting FIG. 2A the as-received untreated PP, FIG. 2B front side of as-fabricated AlF₃@PP, FIG. 2C back side of as-fabricated AlF₃@PP. FIG. 3 shows characterization results for precursor AlF₃ powders. FIG. 3A shows the X-ray diffraction (XRD) pattern of AlF₃ powder, with all the reflections being indexed as belonging to α-AlF₃ (PDF#: 80-1007). FIG. 3B-3D show scanning electron microscopy (SEM) images of AlF₃ powders, highlighting their morphology. Energy-dispersive X-ray spectroscopy (EDXS) maps of Al and F are shown in FIG. 3E. FIGS. 1A-1C are SEM images of the tape cast 30 μm AlF₃ coating on the PP surface, shown in top-down view and in cross-sectional view. It may be observed that the coating is uniform in thickness, with the AlF₃ particle distribution as seen on the surface being relatively uniform as well. The relatively uniform distribution of the AlF₃ particles is further highlighted by EDXS maps of Al, F, and O elements, shown in FIG. 1D. Without wishing to be bound by any theory, it was hypothesized that the jagged “star-like” morphology of the AlF₃ particles can be beneficial for increasing the overall surface roughness of the separator, which will promote the wetting of the electrolyte. In addition, wetting can be promoted through purely geometrical effects where a roughened surface offers a greater contact area with the droplet than a planar surface. At the atomic level, the liquid-solid interface remains unchanged, but macroscopically the droplet spreads further and achieves a lower wetting angle.

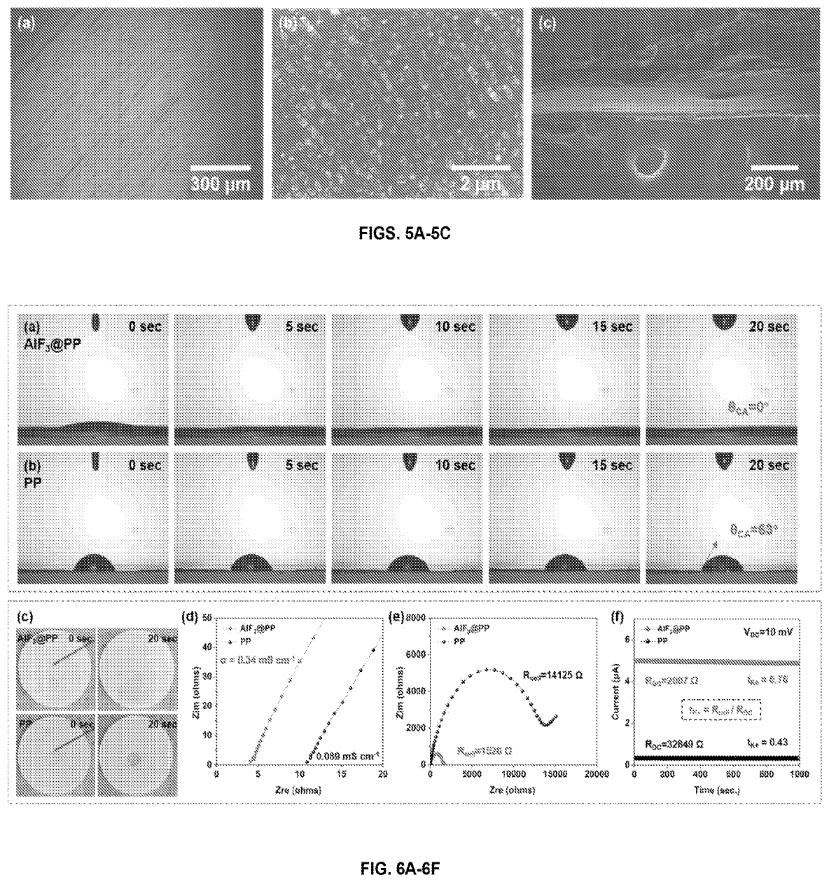

The AlF₃ coating on AlF₃@PP was further analyzed by X-ray photoelectron spectroscopy (XPS) and Raman spectroscopy. FIGS. 1E-1F and FIG. 4 show XPS characterization for AlF₃@PP, precursor AlF₃ powders, and the baseline PP. The F 1s and Al 2p spectra are presented in FIG. 1E and FIG. 1F, respectively. The spectra for AlF₃@PP and precursor AlF₃ yield characteristic peaks for F 1s at 686.8 eV and for Al 2p at 76.8 eV. Raman analysis in FIG. 1G reveals analogous spectra for AlF₃@PP and AlF₃ powders, with the PP signal not being discernable. This indicates that the AlF₃ layer effectively covers the entire surface of PP. FIGS. 5A-5C shows the differing magnification SEM images highlighting the morphology and pore sizes in the baseline PP separator. Such a commercial standard PP has a thickness of 25 μm, pore size distribution from 0.05 μm to 0.1 μm, and porosity of 41%.

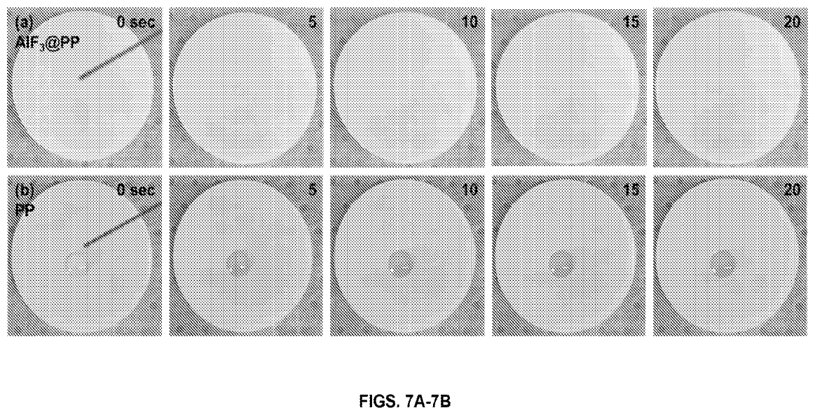

FIG. 6A-6B presents a series of time-lapse photographs that highlight the wetting behavior of 4M potassium bis(fluoroslufonyl) imide (KFSI) in dimethoxyethane (DME) electrolyte on AlF₃@PP separator and baseline PP separator, respectively. FIG. 6C shows the macro photographs of AlF₃@PP vs. PP at the beginning state and ending state of wetting. The associated full set of continuous time-lapse photographs are shown in FIG. 7. For AlF₃@PP, wetting rapidly occurs after the electrolyte droplet lands on its surface, per FIG. 6A and FIG. 6C and FIG. 7A. The measured contact angle θ_{CA} is 0°, indicating that full wetting is obtained. FIGS. 6B-6C and FIG. 7B shows the electrolyte wetting results on the baseline PP. The contact angle θ_{CA} was measured as 63°, which means that the electrolyte's wetting on a commercial PP separator is unsatisfactory. After 20 seconds, the baseline PP is not wetted by the electrolyte and remains non-wetted afterward.

Without wishing to be bound by any theory, it was hypothesized that the improved electrolyte wettability on AlF₃@PP is related to the surface roughness enhancement by the coating, which is considered an extrinsic factor that promotes wetting due to increased geometrical area of contact. It was further assumed that might also be aided by an intrinsically improved wetting behavior due to the differences in surface tensions with AlF₃ and PP. For PP, the surface tension is around 33 mN m⁻¹. The surface tension of AlF₃ depends on the crystallographic orientation and has been calculated using Density Functional Theory. These surface tension values range from 1.43 to 10.95 N m⁻¹, which is two to three orders of magnitude higher than for PP. The surface tension of pure DME has been reported as 11 mN m⁻¹ at room temperature. While the KFSI-DME electrolyte with different concentrations will have different values, they would not be affected by the type of separator employed. One could make a qualitative argument that there may be an intrinsic wetting enhancement due to the significantly higher surface tension of AlF₃, although neither of the interfacial tensions is known. Separator electrolyte uptake was determined by soaking the separators in 4M KFSI in DME for 24 hours. Electrolyte uptake is straightforwardly defined as the weight after solvent adsorption minus the initial weight, divided by the initial weight. The uptake with AlF₃@PP is 823%, while it is 294% for PP. It should be pointed out that enhanced electrolyte uptake with AlF₃@PP does not equate to a heavier cell since the volume of the electrolyte is normally fixed (including in this study). The higher uptake with AlF₃@PP means more electrolytes can be trapped in the separator pores, which is beneficial for ion transport.

To further understand K ion transport behavior in 4M KFSI-DME electrolyte through the two separators, the K⁺ conductivity (σ) and transference numbers (t) were measured. The K⁺ conductivity was evaluated by electrochemical impedance spectroscopy (EIS), shown in FIG. 6D. It may be observed that AlF₃@PP exhibited significantly lower resistance than baseline PP. The K⁺ conductivity of the AlF₃@PP separator is 0.34 mS cm⁻¹ versus 0.089 mS cm⁻¹ for PP. The transference numbers were obtained from alternating-current (AC) impedance and direct-current (DC) polarization measurements performed on a symmetric K//K cell, as shown in FIG. 6E and FIG. 6F, respectively. The K⁺ transference number of the AlF₃@PP separator is 0.76 versus 0.43 for PP. The differences in the ion transport characteristics between AlF₃@PP and PP will help to explain the differences in their electrochemical plating and stripping performance.

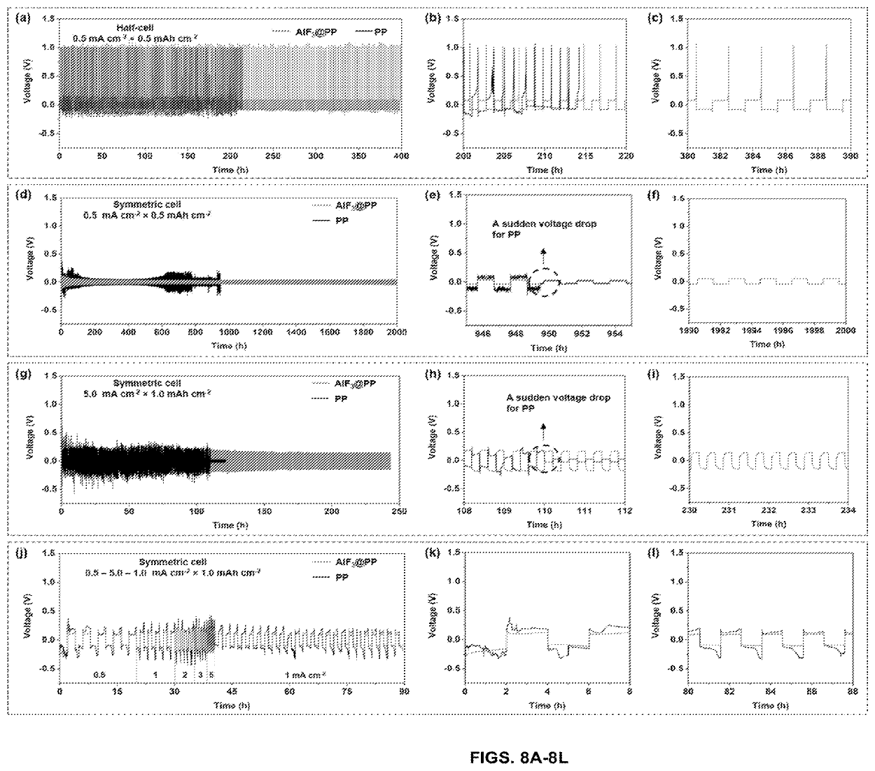

FIG. 8 presents a comparison of the galvanostatic cycling results for the functional AlF₃@PP separator and baseline PP separator. The employed electrolyte was 4M KFSI in DME without any additives. To standardize the measurement, a fixed amount (80 μL) of electrolyte was used in each coin cell. More details of the electrochemical testing procedure are provided in the Supporting Information. In each row of FIG. 8, the second and third panels are the enlarged profiles in the first larger panel. FIGS. 8A-8C show half-cells, namely half-cell AlF₃@PP vs. half-cell PP. For the half cells, the Coulombic efficiency (CE) can't be 100%. Therefore, an anodic voltage cutoff of 1 V is employed, after which point the current is reversed. The rest of FIG. 8 shows the galvanostatic performance of symmetric cells. FIGS. 8D-8I compare the cycling performance of symmetric AlF₃@PP and symmetric PP and FIGS. 8J-8L compare their rate performance. For cycling and rate testing of symmetric cells, the current density and time are the same for the opposing stripping and plating cycle.

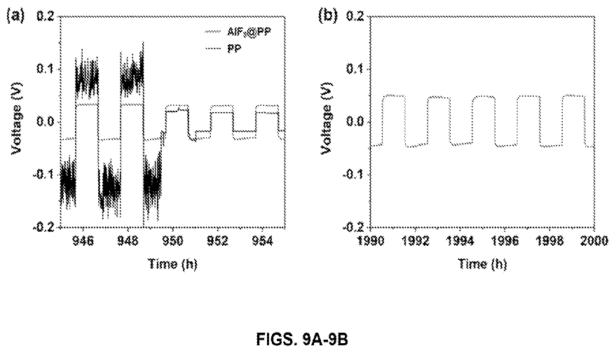

Significant differences in the voltage-time profiles of AlF₃@PP versus the baseline PP are observed. The half-cell AlF₃@PP exhibits stable plating and striping for the entire 200 cycles (398 hours). For symmetric cells, stable plating and striping at 1000 cycles (2000 hrs) at 0.5 mA cm⁻² and a capacity of 0.5 mAh cm⁻² are achieved. Even at a high current of 5 mA cm⁻² and 1.0 mAh cm⁻², the symmetric cell is still stable for 600 cycles (14,400 minutes). By comparison, the baseline PP cells are not stable in either configuration from FIGS. 8A-8C, the half-cell PP shows large overpotentials at each cycle. It may be observed that after the 120^{th} cycle (207 hrs), there is minimal capacity stripped at each cycle. Prior to finally shorting, the overpotential drastically increases, a process associated with severe impedance rise due to thickened SEI layer and other ion transport limitations. For symmetric PP cell in FIGS. 8D-8I violent voltage fluctuations at each cycle are present. Tests at 0.5 mA cm⁻² and 0.5 mAh cm⁻² are shown in FIG. 8E and FIG. 9A. Electrical “soft shorts” (mixed ion-electron conduction) may occur at the 390^{th} cycle (780 hours), leading to a sudden voltage drop, albeit not entirely to zero. A more significant voltage drop occurs at the 475^{th} cycle (950 hours), followed by a square shaped, effectively zero overpotential profile. At 5 mA cm⁻² and 1.0 mAh cm⁻², electrical shorting with a sudden and distinct voltage drop is observed at the 273^{rd} cycle (109 hours).

Results for varied current density tests of symmetric AlF₃@PP and baseline PP are shown in FIGS. 8J-8L. The current density increased from 0.5 to 5.0 mA cm⁻² and then back to 1.0 mA cm⁻². The corresponding plating/stripping time is varied accordingly so as to achieve the targeted 1.0 mAh cm⁻² per cycle. For the rate performance of symmetric cells, the testing protocol was the following: 0.5 mA cm⁻² from 1 to 5 cycle, 1.0 mA cm⁻² from 6 to 10 cycle, 2.0 mA cm⁻² from 11 to 15 cycle, 3.0 mA cm⁻² from 16 to 20 cycle, 5.0 mA cm⁻² from 21 to 25 cycle, and then back to 1.0 mA cm⁻² from 36 to 50 cycle. The AlF₃@PP cell can sustain a current density of up to 5 mA cm⁻² without voltage instability or shorts. When the current density is then turned back to 1.0 mA cm⁻², the sample keeps cycling in a stable manner for the following cycles. By contrast, the PP shows a large fluctuation of voltage and large overpotential, as shown in FIGS. 8J-8L. Table 1 shows a comparison of the electrochemical performance of AlF₃@PP versus a wide survey of the state-of-the-art literature-reported K metal anodes. Both carbonate-and ether-based electrolytes are included in this broad comparison. It may be observed that the overall electrochemical performance of AlF₃@PP is among the most favorable.

TABLE 1
Electrochemical performance comparison of AlF₃@PP versus
state-of-the-art potassium metal anodes from literature.

| | | | Current- | | | Voltage |
|---|---|---|---|---|---|---|
| | | Cell | capacity density | | CE | hysteresis |
| Electrodes | Electrolyte | const. | (mA cm⁻²-mAh cm⁻²) | Cycles | (%) | (V) |
| AlF₃@PP | 4M KFSI in | half-cell | 0.5-0.5 | 200 | 99.3 | 0.072 |
| (this work) | DME | | | | | |
| | | symmetric | 0.5-0.5 | 1000 | 99.99 | 0.042 |
| | | cell | 5.0-1.0 | 600 | 99.98 | 0.138 |
| | | | 0.5-1.0 | 1-5 | 100 | 0.089 |
| | | | 1-1.0 | 6-10 | 100 | 0.12 |
| | | | 2-1.0 | 11-15 | 100 | 0.16 |
| | | | 3-1.0 | 16-20 | 99.98 | 0.18 |
| | | | 5-1.0 | 21-25 | 99.94 | 0.21 |
| | | | 1-1.0 | 26-30 | 99.99 | 0.096 |
| Al@Al | 4M KFSI in | half-cell, | 0.5-0.5 | 1000 | 98.9 | 0.17 |
| | DME | no | | | | |
| | | reservoir | | | | |
| K-Al@Al | | 2 mAh cm⁻² | 0.5-0.5 | 220 | 99.99 | 0.11 |
| | | | 3.0-0.5 | 130 | 99.81 | 0.29 |
| | | reservoir- | (0.1-3-0.5)-0.5 | 151 | >99.6 | 0.11-0.53-0.14 |
| | | contained | | | | |
| | | cell | | | | |
| rGO coated | 0.8M KPF₆ | symmetric | 0.5-0.5 | 100 | 99.99 | 0.36 |
| 3D-Cu | in 2:1:2 | | (0.1-2-0.5)-0.5 | 50 | >99.9 | 0.13-0.51-0.31 |
| | v/v/v | half-cell | 0.5-0.5 | 100 | 76 | 0.37 |
| | EC/DEC/PC | | 1-0.5 | 100 | 60 | 0.58 |
| Convent. | 0.8M KPF6 | half-cell | 0.05-0.15 | 20 | <50 | N/A |
| | in 1:1 v/v | | | | | |
| Cu foil | EC/DEC | | | | | |
| | 1M or 5M | half-cell | 0.05-0.15 | 100 | 99 | ~0.15 |
| | KFSI in | | | | | |
| | DME | | | | | |
| K metal | 1M KFSI in | symmetric | 1.0-1.0 | 100 | N/A | ~0.6 |
| stick on Cu | 1:1 v/v | | | | | |
| foil | EC/DEC | | | | | |
| K metal | 1M KFSI in | symmetric | 1.0-1.0 | 100 | N/A | ~0.6 |
| stick on Cu | 1:1 v/v | | | | | |
| foil | EC/DEC | | (1-5)-1.0 | 60 | N/A | 0.4-0.9 |
| K deposited | 1M KPF₆ in | symmetric | 0.4-0.2 | 200 | 99.62 | ~0.5 |
| on the | 1:1 v/v | | | | | |
| C/NiO | EC/DEC | | | | | |
| coated Cu | | | | | | |
| foil | | | | | | |
| K infused in | 0.8M KPF₆ | symmetric | 0.5-0.5 | 150 | N/A | 0.3 |
| MXene/CNT | in 1:1 v/v | | | | | |
| | EC/DEC | | (0.1-2)-0.5 | 100 | N/A | 0.11-0.4 |
| K infused in | 0.8M KPF₆ | symmetric | 1.0-1.0 | ~110 | N/A | ~0.2 |
| CNTs | in 1:1 v/v | | | | | |
| | EC/DEC | | | | | |
| K metal | 1M KTFSI | symmetric | 0.1-0.02 | 200 | N/A | ~0.35 |
| with | in DME | | | | | |
| electroche | | | | | | |
| mical | | | | | | |
| polishing | | | | | | |
| SEI | | | | | | |
| Sn-based | 5M KFSI in | symmetric | 0.2-1.0 | 50 | N/A | 0.009 |
| SEI coated | DME | | 1-1.0 | 100 | N/A | 0.031 |
| 3D-K | | | | | | |
| K metal | 2M KFSI in | asymmetric | 0.5-0.13 | 500 | 99.6 | ~0.3 |
| stick on Cu | TEP | | | | | |
| foil | | | 1-1.0 | 375 | N/A | 0.13 |
| | | symmetric | | | | |
| K metal | 3.9M KFSA | symmetric | 0.025-0.25 | 15 | N/A | 0.05 |
| stick on Cu | in DME | | | | | |
| foil | | | | | | |
| | 1M KFSA | | | 15 | N/A | ~0.6 |
| | in PC | | | | | |
| | 1M KFSA | | | 15 | N/A | ~0.08 |
| | EC/DEC | | | | | |
| | 1M KPF₆ in | | | 10 | N/A | >2 |
| | PC | | | | | |
| | 1M KPF₆ | | | 15 | N/A | ~0.1 |
| | EC/PC | | | | | |
| | 0.8M KPF₆ | | | 15 | N/A | ~0.1 |
| | EC/DMC | | | | | |
| | 0.8M KPF₆ | | | 15 | N/A | ~0.1 |
| | EC/DEC | | | | | |
| | with 1 | | | 15 | N/A | ~0.6 |
| | vol % of | | | | | |
| | FEC | | | | | |
| | with 1vol % | | | 15 | N/A | ~0.6 |
| | of DFEC | | | | | |
| | with 1 | | | 15 | N/A | ~0.5 |
| | vol % of | | | | | |
| | VC | | | | | |
| | with 1 | | | 15 | N/A | ~0.15 |
| | vol % of ES | | | | | |

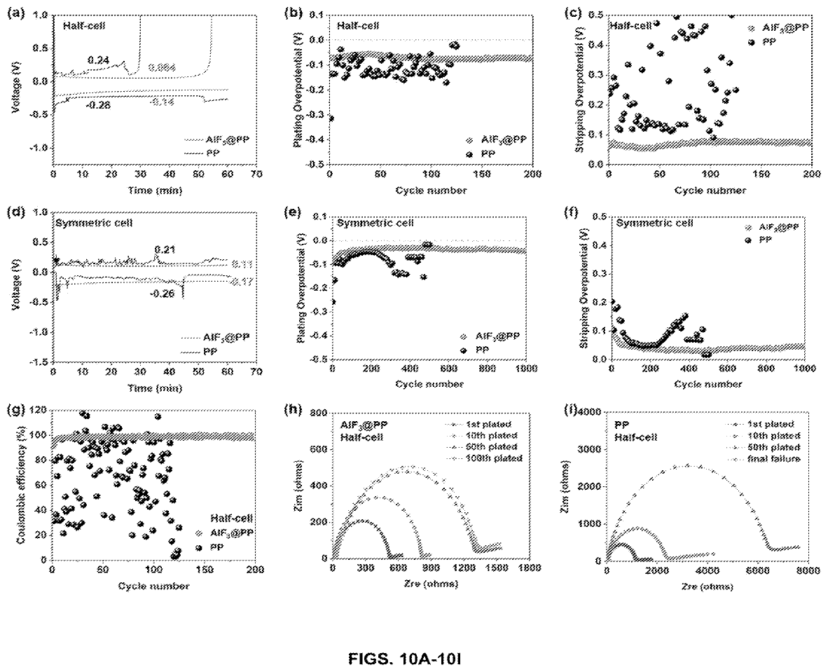

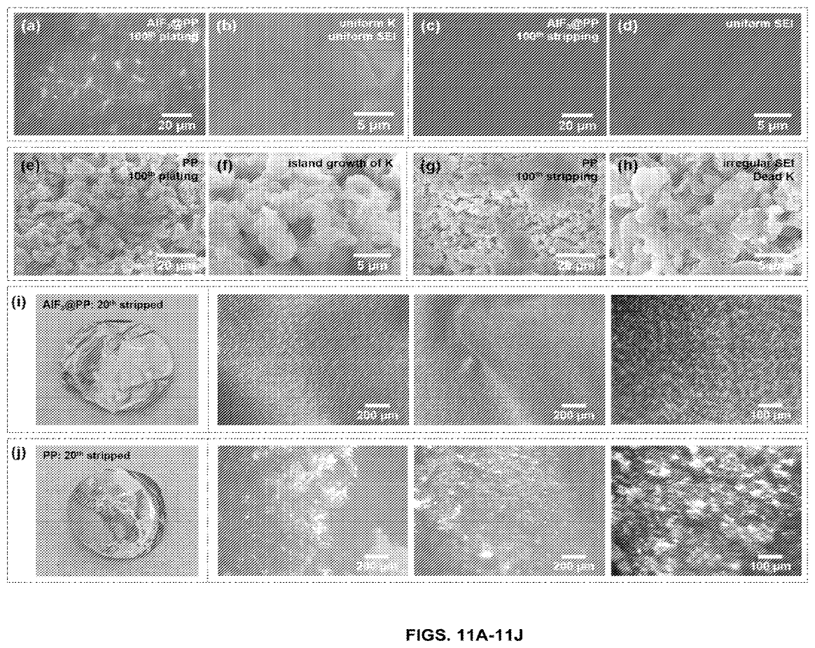

FIG. 10 presents a comparison of the electrochemical analysis results for the functional AlF₃@PP separator and baseline PP separator. First cycle plating and stripping galvanostatic profiles for half-cell AlF₃@PP and baseline PP are shown in FIG. 10A. Stripping and plating overpotential were calculated separately from the associated plateau voltages, based on the 0.5 mA cm⁻² results. FIGS. 10B-10C compare the plating and stripping overpotentials for half-cell AlF₃@PP and baseline PP. First cycle plating and stripping galvanostatic profiles for symmetric AlF₃@PP and baseline PP are shown in FIG. 10D. FIGS. 10E-10F compare the plating and stripping overpotentials for symmetric AlF₃@PP and baseline PP. By considering the plating/stripping platform voltages, the steady-state plating/stripping behavior can be quantified. The unstable voltage profiles of PP can be clearly observed from the first cycle onward, while AlF₃@PP shows stable profiles. The cycle 1 plating overpotentials of half-cell AlF₃@PP and PP are −0.14 V and −0.28 V, respectively. The stripping overpotentials of half-cell AlF₃@PP and PP are 0.064 V and 0.24 V, respectively. The cycle 1 plating overpotentials of symmetric AlF₃@PP and PP are −0.17 V and −0.26 V, respectively. The stripping overpotentials of symmetric AlF₃@PP and PP are 0.11 V and 0.21 V, respectively. In cycle 1, AlF₃@PP exhibits a substantially smaller overpotential in both plating and stripping. This signals that metal growth should be planar rather than island-like.

Throughout cycling, the half-cell and symmetric AlF₃@PP display lower and more stable overpotentials. This is associated with more facile plating/stripping kinetics and a thinner SEI layer. The degree of SEI thickening during cycling gives an indication of the degree to which the overpotentials will concomitantly increase. An unstable, rapidly thickening SEI layer has been shown to be associated with similarly increasing overpotentials at each cycle. The overpotentials rapidly drop only once the sample is electrically shorted, with mixed electrical/ion conduction actually still yielding a non-zero value. After 200 cycles, half-cell AlF₃@PP plating and stripping overpotentials are −0.072 V and 0.073 V, respectively. For symmetric AlF₃@PP, plating and stripping overpotentials are at −0.042 V and 0.043 V after 1,000 cycles. By contrast, the baseline PP shows a rapid increase in plating/stripping overpotential prior to its ultimate failure by shorting. For example, the stripping overpotential of half-cell PP is at 0.137 V at 109 cycles (189 hrs), rapidly increasing to 0.55 V at 123 cycles (210 hrs). The plating overpotential of PP is −0.142 V at 109 cycles (189 hrs), dropping to −0.017 V at 123 cycles (210 hrs), at which point the sample is failed. For symmetric PP, the behavior is analogous: The plating/stripping overpotentials first rapidly increase with cycle number, followed by a sudden drop. At the 380^{th} cycle (760 hours), the plating and stripping overpotentials of PP rapidly increase to −0.14 V and 0.15 V, respectively. But, at the 390^{th} cycle (780 hours), the plating and stripping overpotentials of PP decrease to −0.07 V and 0.07 V, and then further decrease to −0.017 V and 0.017 V at the 475^{th} cycle (950 hours), indicating complete shorting.

In a half-cell configuration without a metal reservoir on the working electrode, low Coulombic efficiency (CE) is indicative of uncontrolled SEI growth and possibly of “dead metal” formation. As shown in FIG. 10G half-cell AlF₃@PP shows a relatively high and consistent CE value through the entire cycling range, and a CE of 99.3% retained even after 200 cycles. In contrast, the baseline PP shows overall unsatisfactory CE values. After about 120 cycles, the CE of PP approaches zero, indicating that the majority of the K metal is not recovered upon the stripping cycle. Limited cycling is presumably occurring on the pre-existing dendrites. This results in the cell electrical shorting, agreeing with the results of overpotentials. Because the CE of symmetric cells remains close to 100% owing to the presence of the both-side large K reservoir, symmetric-cell CE values cannot be used to ascertain the state of cell health. Electrochemical impedance spectroscopy (EIS) analysis for half-cell AlF₃@PP and baseline PP was conducted. The EIS tests were performed at an open-circuit voltage in the fully plated state. Nyquist plots for half-cell AlF₃@PP and baseline PP specimens after different cycle numbers are shown in FIGS. 10H-10I and in Table 2, respectively. The model employed for the EIS fits is also provided in Table 2. There is a consistent trend that at cycle 20, both the R_{CT} (charge transfer resistance between the electrolyte and electrode) and R_{SEI} (SEI layer resistance) are significantly higher for the baseline PP, agreeing with the overpotential and CE results.

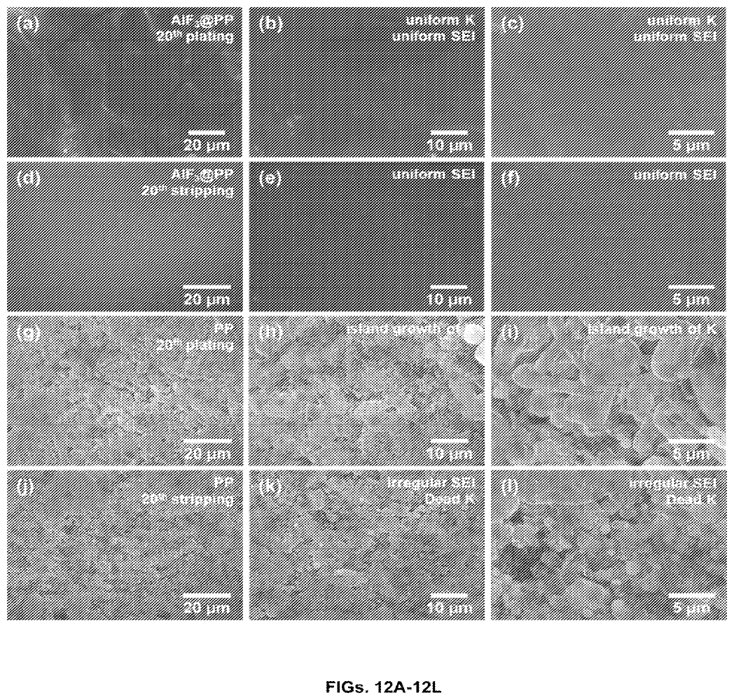

FIGS. 11A-11H and 12 show top-down SEM images with an increased magnification of the fully plated or fully stripped K metal anode surfaces from half cells. The analysis was performed on half-cells of AlF₃@PP and PP, tested at 0.5 mA cm⁻² at cycle 20 (FIG. 12) and cycle 100 (FIG. 11).

TABLE 2
EIS Impedance values for AI@AI and baseline AI foil during
cycling.

| AI@AI | | | AI baseline | | |
|---|---|---|---|---|---|
| | R_{SEI} (Ω) | Rct (Ω) | | R_{SEI} (Ω) | Rct (Ω) |
| 1st plated | 0.41 | 542.3 | 1st plated | 0.47 | 1313 |
| 20th plated | 1.29 | 827.6 | 20th plated | 10.28 | 2895 |
| 50th plated | 24.54 | 1341 | 50th plated | 61.14 | 6923 |
| 100th plated | 30.17 | 1356 | final failure | N/A | 93.28 |

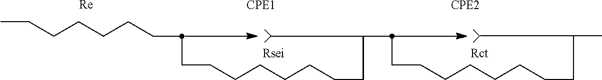

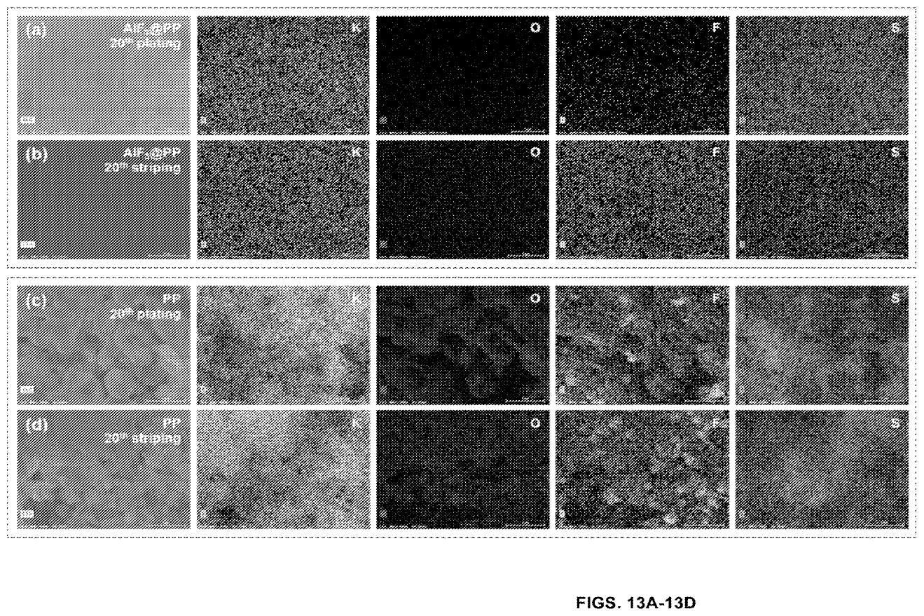

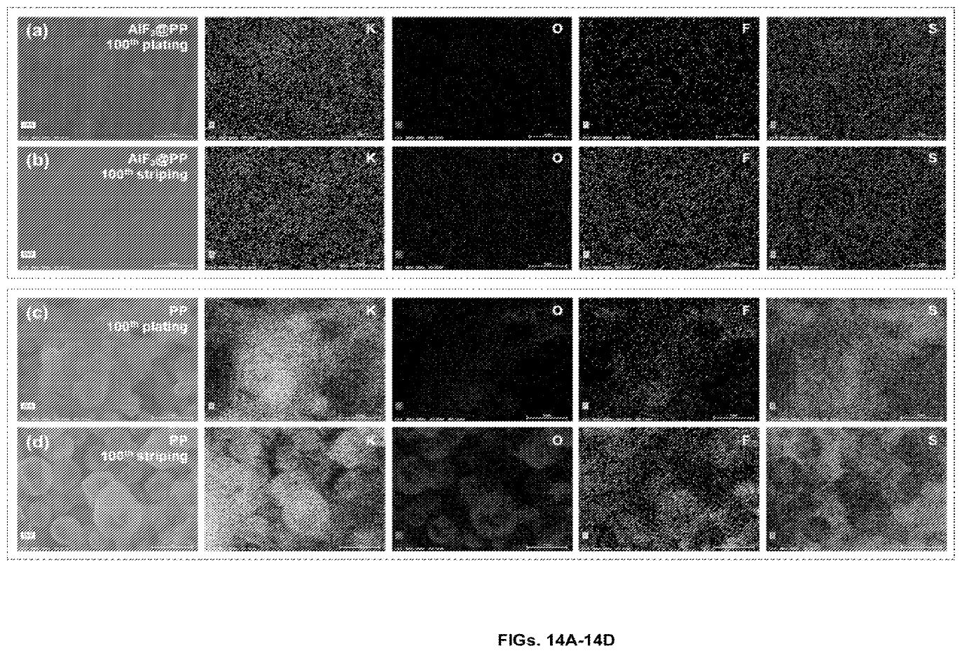

FIGS. 13 and 14 show the EDXS maps of both specimens in plated and stripped state at cycle 20 and cycle 100. FIGS. 11A-11B and FIGS. 11C-11D show the top-down SEM images of AlF₃@PP, in plated and in the stripped state, respectively. FIGS. 11E-11H show comparable SEM image analysis for PP. It may be observed that for AlF₃@PP, the plated K metal at cycles 20 and 100 is fully planar. Moreover, the stripped AlF₃@PP specimen does not display remnant clumps of macroscopically visible SEI, rather having a smooth and conformal SEI layer that is difficult to resolve optically. Based on the EDXS maps, the K, O, F, and S appear uniform in plated and stripped states. By contrast, the PP shows irregular island-like patterns of K metal and SEI both at cycles 20 and 100, discernable in the secondary electron images. To confirm the existence of “dead metal” on the stripped PP surface but not on the AlF₃@PP, light optical photographs were conducted on the half-cells at the 20^{th} stripped state, as shown in FIGS. 11I-11J. The low magnification “macro” images were obtained with a cell phone while the dissembled and cleaned specimens were kept in the glove box. The high magnification images were obtained using a light optical microscope. For that analysis, the specimens were removed from the glove box but kept in a Ziplock bag, preventing rapid oxidation. With light optical imaging, the metallic K is shiny, whereas K incorporated into the SEI phases is not. It may be observed that the surface of the stripped PP current collector has a significant amount of metallic K on it, confirming the “dead metal” (also called “dead potassium”) scenario. The stripped AlF₃@PP does not have any detectable K metal on it. Both sets of findings agree with the electrochemical CE results. This indicates that poor electrolyte wetting and other problems associated with PP not only lead to excessive SEI formation but also to the inability to fully strip the K metal at every cycle.

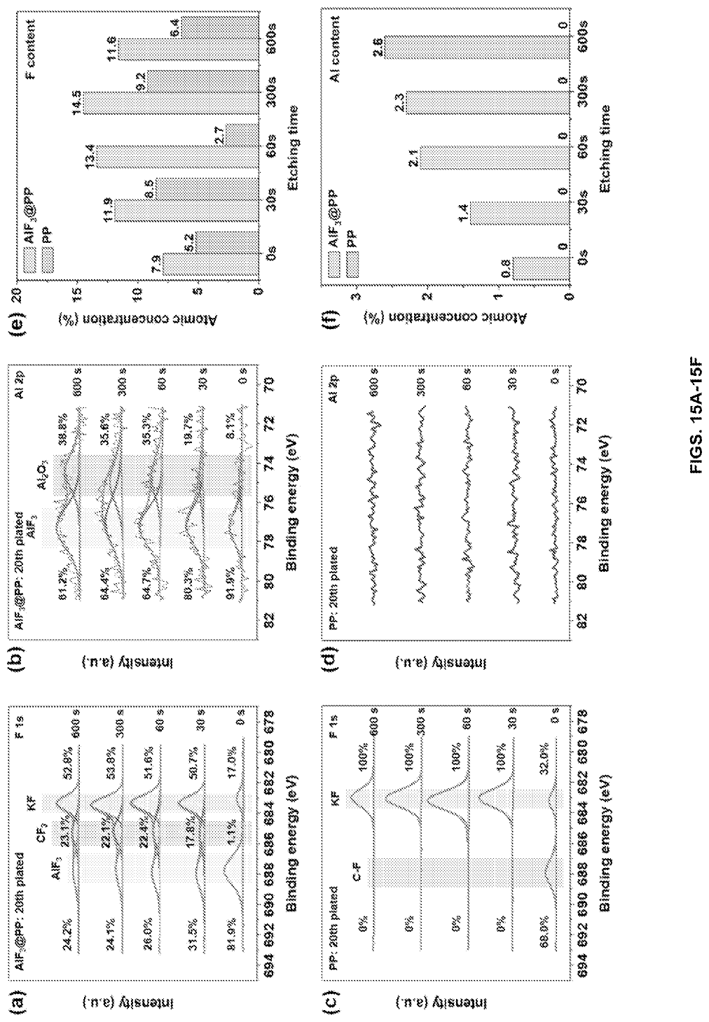

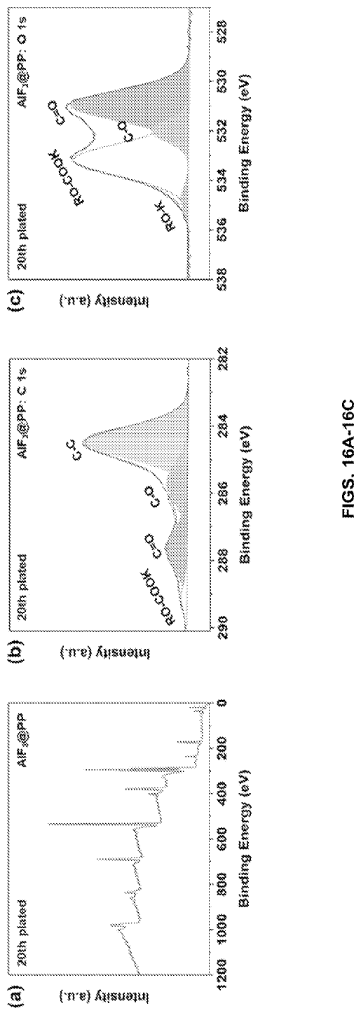

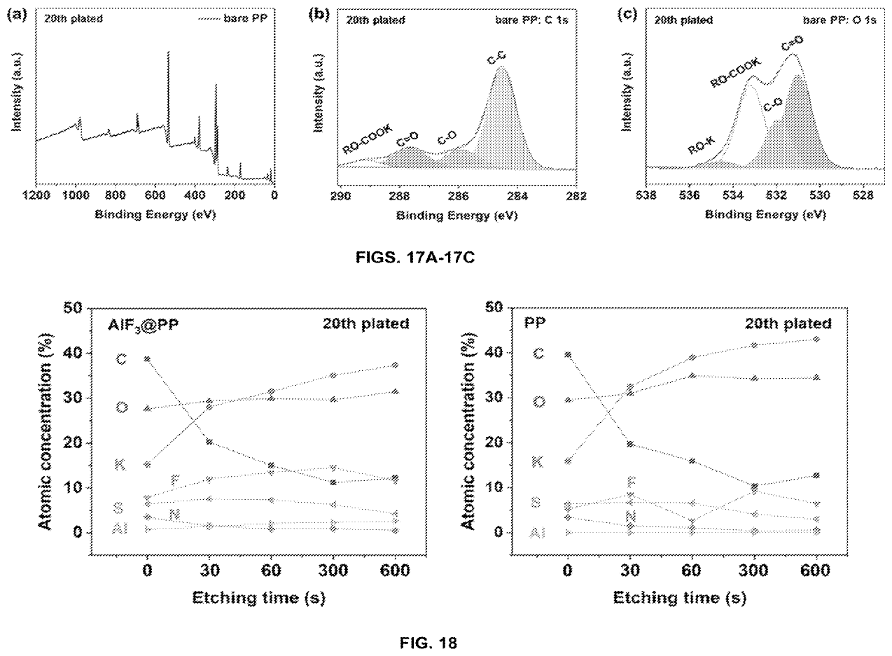

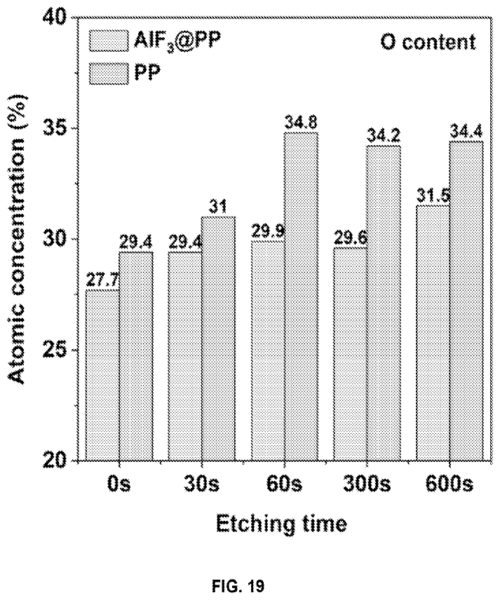

Sputter etching XPS analysis was employed to further understand the differences in the SEI phase content for the cycled AlF₃@PP and PP cells. Specimens were analyzed after the 20^{th} plating cycle. FIGS. 15A-15B show the XPS analysis for AlF₃@PP, displaying high-resolution F 1s and Al 2p spectra with increasing sputtering time. FIG. 16 shows the survey, fitted C 1s, and fitted O 1s spectra of AlF₃@PP. FIGS. 15C-15D and FIG. 17 show the XPS analysis for PP under the same conditions. The atomic percentage concentrations with increasing etching time are shown in FIGS. 15E-15F and FIGS. 18-19. For both PP and AlF₃@PP, the C 1s peak can be fitted into four separated peaks of C—C (284.5 eV), C—O (286.5 eV), C═O (287.9 eV), and RO—COOK (289.2 eV). The O 1s peak can be fitted into four separated peaks of C═O (531.0 eV), C—O (532.0 eV), RO—COOK (533.2 eV), and RO—K (534.8 eV). The F 1s spectra exhibit two peaks around 682.8 (K—F) and 686.8 eV (C—F or AlF₃). For AlF₃@PP, an additional peak around 685 eV (possible CF₂or other CF species) in F 1s spectra is present. Moreover, the Al 2p spectra of AlF₃@PP exhibit two peaks around 74.6 (Al₂O₃) and 77.2 eV (AlF₃).

For baseline PP, when the sputtering time is 0 seconds (outer SEI), KF and C—F can be detected in F 1s spectra, their relative content being 32% and 68%. When sputtering time increases to 30 seconds, and longer time (inner SEI), only KF can be detected in F 1s spectra. As shown in FIG. 15E, the absolute content of F in the SEI associated with PP fluctuates with sputtering time, indicating an inhomogeneous phase distribution. The content of F is consistently lower for PP than for AlF₃@PP. For the PP baseline, the outer SEI consists of KF and C—F, and while only KF exists in the inner SEI. There is no C—F peak in F 1s spectra after sputtering, which means that the inner SEI does not contain C—F.

For AlF₃@PP, two fitted peaks of Al₂O₃ and AlF₃ are present in the Al 2p spectra at all sputtering times. The relative content of Al₂O₃ increases from 8.1% to 38.8% as sputtering time increases from 0 seconds to 600 seconds. As shown in FIG. 15F, the absolute content of Al in the SEI increases with sputtering time going from 0.8% to 2.6%. At 0 second sputtering time, the F 1s spectra of AlF₃@PP exhibit three peaks around 682.8 (K—F), 686.8 eV (mixing overlapped C—F and AlF₃), and 685 eV (slight CF₂ or other CF species). When sputtering time increases to 30 seconds, and longer time, the peak around 686.8 eV can be confirmed as AlF₃ because the AlF₃ signal is detected in the Al 2p spectra at all sputtering times. The relative content of KF shows an increasing trend from 17.0% to 52.8%, with sputtering time increasing from 0 seconds to 600 seconds. Moreover, the absolute content of the F element in the SEI shows an increasing trend with sputtering, going from 7.9% to 14.5. It is noteworthy that the absolute content of F for AlF₃@PP is higher than that of PP at each sputtering time. With AlF₃@PP, the Al₂O₃ and CF₂ (or other CF species) may originate from the possible electrochemical reaction of AlF₃ and semicarbonates (e.g., RO—COOK) during cycling. One possible reaction scheme is the following: AlF₃+O—COOK→KF+Al₂O₃+CF₂ (or other CF species).

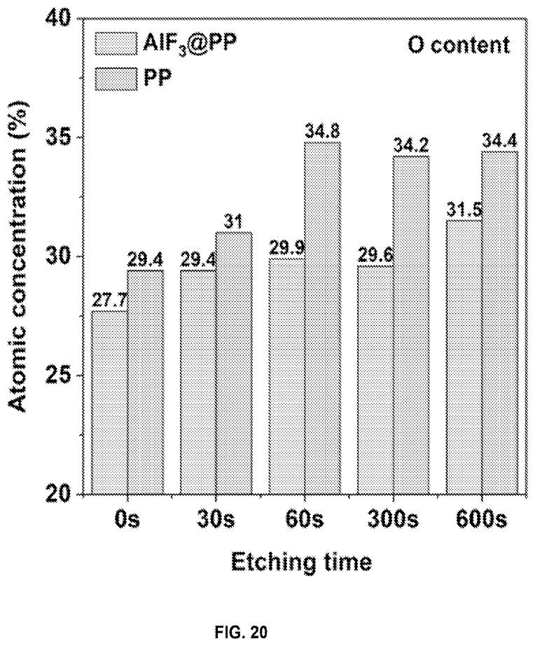

In summary, the SEI of cycled AlF₃@PP contains KF, AlF₃, CF₂ (or other CF species), and Al₂O₃, with the F-containing species content being higher than for the baseline PP. It has been reported that the presence of KF in the SEI structure should allow for faster K⁺ ion diffusion and enhanced mechanical toughness. Meanwhile, Al₂O₃ has been reported to be beneficial in suppressing the corrosion of K metal anode and enhancing the strength of SEI. As shown in FIG. 20, AlF₃ has a higher bandgap (7.72 eV) compared with other species in SEI, such as KF (6.07 eV) and K₂CO₃ (3.63 eV), K₂O (1.77 eV), making it an excellent electrical insulator. This will inhibit further reduction of the electrolyte during cycling, adding to the overall stability of the AlF₃@PP cell throughout a range of electrochemical testing conditions.

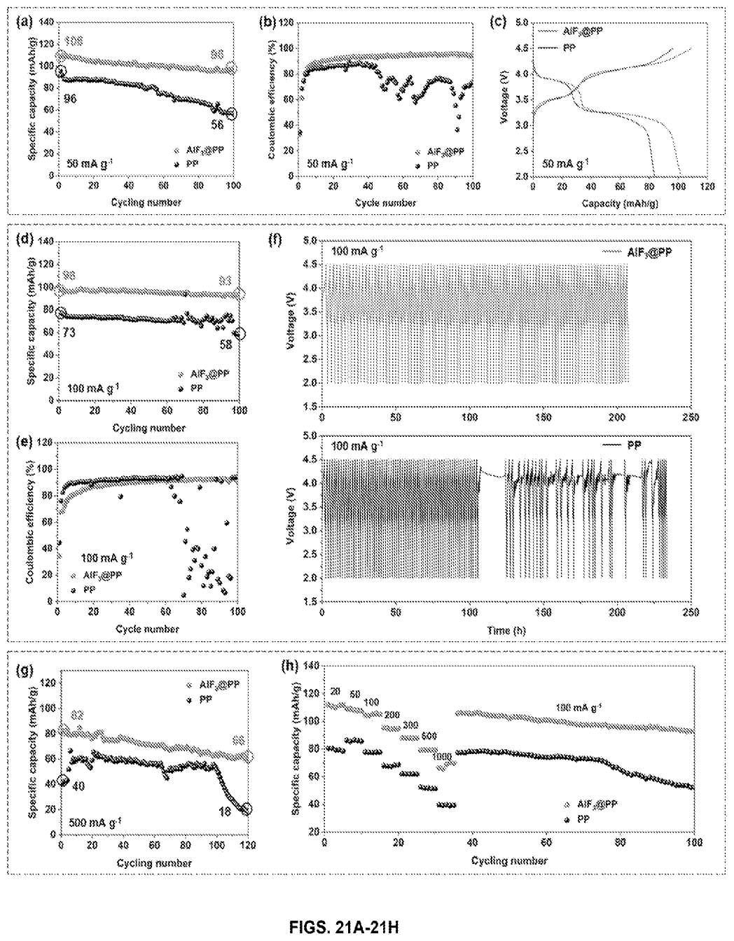

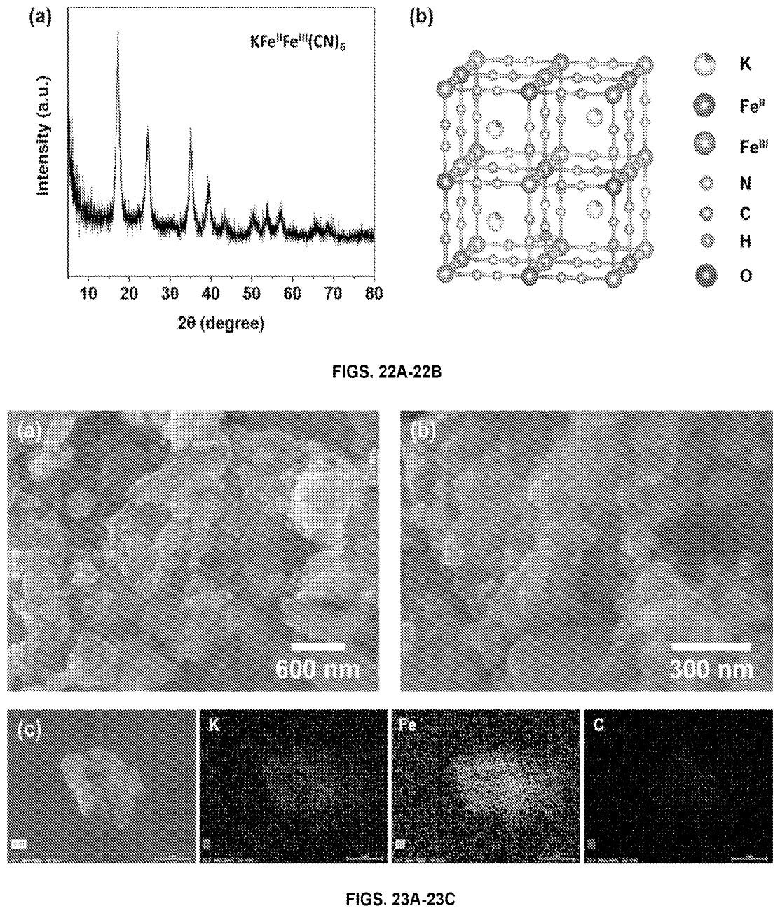

As further proof of the principle, full KMB cells with an in-house fabricated Potassium hexacyanoferrate (III) KFe^{II}Fe^{III}(CN)₆ (one variant of Prussian blue (PB)) cathodes were electrochemically tested. FIG. 22 shows the XRD pattern of PB cathode materials and their crystal structure. FIG. 23 shows the morphology of PB nanoparticles. FIG. 21 shows the electrochemical performance comparisons of full metal battery cells with AlF₃@PP separator and with baseline PP separator. FIGS. 21A-21C show the comparison of cycling performance, CE, and charge-discharge curves at a current density of 50 mA g⁻¹. FIGS. 21D-21F show the comparison of cycling performance, CE, and entire charge-discharge profiles at 100 mA g⁻¹. FIGS. 21G and 21H show the comparison of cycling performance at 500 mA g⁻¹ and rate performance, respectively. The battery with AlF₃@PP delivers an initial capacity of 108 mAh g⁻¹ at 50 mA g⁻¹. A cell capacity of 98 mAh g⁻¹ is maintained after 100 cycles, corresponding to a capacity retention of 91%. When the current is increased to 100 mA g⁻¹, AlF₃@PP retains a capacity of 93 mAh g⁻¹, corresponding to a capacity retention of 95%. By contrast, the capacity of the battery with PP rapidly decreases to 56 mAh g⁻¹ after 100 cycles at 50 mA g⁻¹, corresponding to a retention of 58%. Moreover, PP displays fluctuations in CE, likely due to the periodic formation of the dead metal on the anode. After 60 cycles, the voltage profile of PP also shows significant fluctuations, likely associated with uneven plating and stripping reactions. The battery with AlF₃@PP shows stable voltage and CE profiles throughout the entire cycling regiment, including at a relatively fast charge.

In summary, FIG. 25 provides a graphic description of how the multifunctional AlF₃@PP separator enhances the electrochemical stability of K metal anodes and ultimately of KMBs. The AlF₃ double layer coating on PP leads to complete electrolyte wetting and enhanced electrolyte uptake. It also leads to improved ion conductivity through the electrolyte infiltrated pores and the increased ion transference numbers. The AlF₃@PP, therefore, performs as an ion self-distributor to facilitate more uniform and rapid K ion flux to the current collector, resulting in more uniform K plating/stripping fronts. AlF₃@PP also plays a key role in establishing an artificial SEI on the K metal surface. The AlF₃ facilitates the formation of stable KF, Al₂O₃, and AlF₃ SEI layers. This should add to the elastic and plastic stability of the SEI while creating new interfaces that are not further reactive.

In contrast, the baseline PP displays poor electrolyte wetting, which is an issue that even by itself would create major problems during cycling. With poor electrolyte wetting, the result is a “clumpy” post-stripped SEI structure, exacerbating the nonuniformity of the metal growth/dissolution during plating/stripping. The baseline PP also results in more anisotropic ion distribution and more sluggish ion diffusion across the separator, resulting in further unevenness in the SEI structure and geometry. With PP, there are light optical observations of potassium islands termed “dead metal” or “dead potassium” on stripped surfaces. The measured cycling-induced rapid impedance and overpotential rise, as well as low cycling CE, are indicative of these problems.

### Exemplary Aspects

In view of the described processes and compositions, hereinbelow are described certain more particularly described aspects of the disclosures. These particularly recited aspects should not, however, be interpreted to have any limiting effect on any different claims containing different or more general teachings described herein or that the “particular” aspects are somehow limited in some way other than the inherent meanings of the language and formulas literally used therein.

EXAMPLE 1: A multifunctional structure comprising: a first layer comprising a first polymer and having a first surface and a second surface, and a second layer comprising an inorganic-based material deposited on at least the first surface of the first layer, wherein the structure is an electrochemical cell separator.

EXAMPLE 2: A multifunctional structure comprising: a first layer comprising a first polymer and having a first surface and a second surface, and a second layer comprising an inorganic-based material deposited on at least the first surface of the first layer, wherein the inorganic-based material is ionically conducting and wherein the structure is an electrochemical cell separator.

EXAMPLE 3: A multifunctional structure comprising: a first layer comprising a first polymer and having a first surface and a second surface, and a second layer comprising an inorganic-based material deposited on at least the first surface of the first layer, wherein the inorganic-based material is electrically insulating and wherein the structure is an electrochemical cell separator.

EXAMPLE 4: A multifunctional structure comprising: a first layer comprising a first polymer and having a first surface and a second surface, and a second layer comprising an inorganic-based material deposited on at least the first surface of the first layer, wherein the inorganic-based material is semiconducting and wherein the structure is an electrochemical cell separator.

EXAMPLE 5: The multifunctional structure of any one of examples herein, particularly examples 1-4, wherein the second layer further comprises a second polymer different from the first polymer.

EXAMPLE 6: The multifunctional structure of any one of examples herein, particularly examples 1-5, wherein the inorganic-based material comprises at least one of salts, oxides, oxynitrides, sulfides, selenides, phosphides, carbides, nitrides, glass, ceramics, semiconductors, metal and/or alloys thereof, metalloids, intermetallics, or any combination thereof.

EXAMPLE 7: The multifunctional structure of any one of examples herein, particularly examples 1-6, wherein the inorganic-based material comprises one or more of fluorides, chlorides, chlorates, perchlorates, iodates, tetrachloroaluminates, tetrochloroborates, bromates, iodides, phosphates, nitrates, silicates, tellurium, selenium, sulfur, or any combination thereof.

EXAMPLE 8: The multifunctional structure of any one of examples herein, particularly examples 6-7, wherein the metal and/or alloys thereof comprise aluminum, magnesium, calcium, potassium, barium, zinc, tin, yttrium, zirconium, lanthanum, gadolinium, scandium, strontium, sodium, lithium, germanium, silicon, aluminum, or any combination thereof.

EXAMPLE 9: The multifunctional structure of any one of examples herein, particularly examples 1-8, wherein the inorganic-based material comprises one or more of AlF₃, Al₂O₃, TiO₂, SiO₂, BaTiO₃, fluorite Gd_{0.1}Ce_{0.9}O_{1.95}, perovskite La_{0.8}Sr_{0.2}Ga_{0.8}Mg_{0.2}O_{2.55}, a metal-organic framework, graphite oxide, graphene oxide, polyhedral oligomeric silsesquioxanes, Li₂CO₃, Li₃PO₄, BN, Li₃S₄, Li₂O, montmorillonite, zeolite, Li₃N, garnet Li₇La₃Zr₂O₁₂ and Li_{6.4}La₃Zr_{1.4}Ta_{0.6}O₁₂, perovskite Li₃ₓLa_{2/3-x}□_{1/3-2x}TiO₃, where □ is a vacancy and 0.06<x<0.14, anti-perovskite Li₃OX, Li₂OHX, wherein X is Cl, Br, or I, NASICONLi₁₊ₓM′ₓM″₂₋ₓ(PO₄)₃, wherein M′ is Al, Sc, or Y, and M″ is Ti or Ge, Li_{1+x+y}Ti₂₋ₓAlₓSi_{y}(PO₄)_{3-y}, halide Li₃X′Cl₆, wherein X′is Y, In, Zr, Er, or Al, binary sulfide Li₂S—P₂S₅ or Li₂S—MS₂, wherein M is Ge, Si, or Sn, argyrodite Li₆PS₅X, where X is F, CI, Br, or I, thio-LISICON Li₁₀GeP₂S₁₂, AlN, SiC, Si₃N₄, Sr₂Ce₂Ti₅O₁₆, ZrSiO₄, CaSiO₃, SiO₂, BeO, CeO₂, ZnO, MgO, MgCl, bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (LiI), lithium chlorate (LiClO₃), LiBrO₃, LiIO₃, Lithium trifluoromethanesulfonate (LiTF), Lithium difluoro(oxalato)borate (LiODFB), or any combination thereof.

EXAMPLE 10: The multifunctional structure of any one of examples herein, particularly examples Error! Reference source not found.—9, wherein the first polymer comprises a polyolefin, polydopamine (PDA), polyimide (PI), polyetherimide (PEI), poly (ethylene terephthalate) (PET), poly (ethylene oxide) (PEO), polyacrylonitrile (PAN), poly (vinyl chloride) (PVC), poly (vinylidene fluoride) (PVDF), polyvinyl butyral (PVB), poly (methyl methacrylate) (PMMA), or any combination thereof.

EXAMPLE 11: The multifunctional structure of any one of examples herein, particularly example Error! Reference source not found. 10, wherein the polyolefin comprises polyethylene, polypropylene, or a combination thereof.

EXAMPLE 12: The multifunctional structure of any one of examples herein, particularly examples 1-11, further comprising a third layer comprising an inorganic-based material deposited on the second surface of the first layer.

EXAMPLE 13: The multifunctional structure of any one of examples herein, particularly example 12, wherein the second layer deposited on the first surface of the first layer comprises a composition that is substantially similar to a composition of the third layer deposited on the second surface of the first layer.

EXAMPLE 14: The multifunctional structure of any one of examples herein, particularly example 12, wherein the second layer deposited on the first surface of the first layer comprises a composition that is substantially different from a composition of the third layer deposited on the second surface of the first layer.

EXAMPLE 15: The multifunctional structure of any one of examples herein, particularly examples 1-14, wherein the second layer and the third layer, if present, comprise a plurality of nanoparticles, a plurality of microparticles, or a combination thereof.

EXAMPLE 16: The multifunctional structure of any one of examples herein, particularly examples 1-15, wherein the second layer and the third layer, if present, have a thickness from about 1μ to about 50μ.

EXAMPLE 17: The multifunctional structure of any one of examples herein, particularly example 16, wherein the thickness of the second layer deposited on the first surface of the first layer is the same or different as the thickness of the third layer deposited on the second surface of the first layer.

EXAMPLE 18: The multifunctional structure of any one of examples herein, particularly examples 1-17, wherein the second layer and the third layer, if present, have a mass loading of the inorganic-based material about 0.5 mg cm⁻² to about 2 mg cm⁻².

EXAMPLE 19: The multifunctional structure of any one of examples herein, particularly example 18, wherein the mass loading of the inorganic-based material on the first surface of the first layer is the same or different as the mass loading of the inorganic-based material on the second surface of the first layer.

EXAMPLE 20: The multifunctional structure of any one of examples herein, particularly examples 1-19, wherein the second layer and the third layer, if present, have a roughness from about 50 nm rms to about 5 μm rms.

EXAMPLE 21: The multifunctional structure of any one of examples herein, particularly example 20, wherein the roughness of the second layer deposited on the first surface of the first layer is the same or different as the roughness of the third layer deposited on the second surface of the first layer.

EXAMPLE 22: The multifunctional structure of any one of examples herein, particularly examples 15-21, wherein the plurality of nanoparticles or microparticles have a star-like shape, a spheric shape, a non-regular shape, fibrous shape, rod shape, cubic, oval, prism, helical, pillar, or any combination thereof.

EXAMPLE 23: The multifunctional structure of any one of examples herein, particularly examples 15-22, wherein the plurality of nanoparticles or microparticles have an average size from about 50 nm to about 20 μm.

EXAMPLE 24: The multifunctional structure of any one of examples herein, particularly examples 1-23, wherein the multifunctional structure exhibits substantial wettability when exposed to an electrolyte.

EXAMPLE 25: The multifunctional structure of any one of examples herein, particularly example 24, wherein the multifunctional structure exhibits a contact angle from 0° to about 50° when exposed to the electrolyte.

EXAMPLE 26: The multifunctional structure of any one of examples herein, particularly examples 24 or 25, wherein the electrolyte comprises a salt and a non-aqueous solvent.

EXAMPLE 27: The multifunctional structure of any one of examples herein, particularly example 26, wherein the salt comprises a potassium, sodium, or a lithium salt of bis(fluorosulfonyl) imide, trifluoromethanesulfonate, bis(trifluoromethane)sulfonimide, difluoro(oxalato)borate, perchlorate, tetrafluoroborate, hexafluorophosphate, hexafluroarsenate, aluminum tetrachloride, boron tetrachloride iodide, chlorate, borate, iodate, or a combination thereof.

EXAMPLE 28: The multifunctional structure of any one of examples herein, particularly example 26 or 27, wherein the non-aqueous solvent comprises dioxane, ethylene carbonate, dimethyl carbonate, diethyl carbonate, ethyl methyl carbonate, polyoxylene, fluoroethylene carbonate, ethylene carbonate, N-methyl acetamide, N-Methyl-2-pyrrolidone, acetonitrile, symmetric sulfone, sulfolane, polyethylene glycol, 1,3-dioxolane, glymes, siloxane, ethylene oxide grafted sulfolane, toluene, dimethylbenzene, dimethylformamide, dimethyl sulfoxide, tetrahydrofuran, or a combination thereof.

EXAMPLE 29: The multifunctional structure of any one of examples herein, particularly example 1-28, wherein the inorganic-based material is substantially non-reactive when used in an electrochemical cell.

EXAMPLE 30: The multifunctional structure of any one of examples herein, particularly examples Error! Reference source not found.—29, wherein the inorganic-based material is at least partially reactive when used in an electrochemical cell.

EXAMPLE 31: The multifunctional structure of any one of examples herein, particularly example 30, wherein a reaction product of the inorganic-based material is configured to form at least one further layer disposed on the second layer and/or the third layer if present.

EXAMPLE 32: The multifunctional structure of any one of examples herein, particularly example 31, wherein the at least one further layer is a solid-electrolyte interphase (SEI) layer.

EXAMPLE 33: The multifunctional structure of any one of examples herein, particularly examples 1-32, wherein the multifunctional structure exhibits an ion transference number at least 20% greater than an ion transference number exhibited by a substantially identical reference multifunctional structure in the absence of the second layer and/or third layer, if present, wherein the ion transference number is an ion transference number of K, Na, or Li.

EXAMPLE 34: The multifunctional structure of any one of examples herein, particularly examples 1-33, wherein the multifunctional structure exhibits an ion transference number of greater than 0.5, wherein the ion transference number is an ion transference number of K, Na, or Li.

EXAMPLE 35: The multifunctional structure of any one of examples herein, particularly examples 1-34, wherein the multifunctional structure exhibits an ion conductivity for K, Na, or Li from about 0.1 mS/cm to about 1 S/cm.

EXAMPLE 36: The multifunctional structure of any one of examples herein, particularly examples 1-35, wherein the second layer deposited on the first surface of the first layer is configured to face an anode, and the third layer deposited on the second surface of the first layer if present is configured to face a cathode when placed into an electrochemical cell.

EXAMPLE 37: The multifunctional structure of any one of examples herein, particularly examples 1-36, wherein the inorganic-based material is deposited by magnetron sputtering, wet and dry chemistry, chemical and electrochemical deposition, spin coating, spray drying, tape casting, screen printing, thermal and hydrothermal method, or any combination thereof.

EXAMPLE 38: An electrochemical cell comprising: at least one electrode, a separator comprising the multifunctional structure of any one of examples herein, particularly examples 1-37; and an electrolyte.

EXAMPLE 39: The electrochemical cell of any one of examples herein, particularly example 37 or 38, wherein the at least one electrode is an anode and/or cathode.

EXAMPLE 40: The electrochemical cell of any one of examples herein, particularly example 38 or 39, wherein the electrochemical cell is a battery.

EXAMPLE 41: The electrochemical cell of any one of examples herein, particularly example 40, wherein the battery is a metal battery or ion-metal battery.

EXAMPLE 42: The electrochemical cell of any one of examples herein, particularly example 40 or 41, wherein the battery is a secondary battery.

EXAMPLE 43: The electrochemical cell of any one of examples herein, particularly examples 39-42, wherein the anode comprises ions and/or metals of potassium, sodium, lithium, or a combination thereof.

EXAMPLE 44: The electrochemical cell of any one of examples herein, particularly examples 38-43, wherein the electrolyte comprises a salt and a non-aqueous solvent

EXAMPLE 45: The electrochemical cell of any one of examples herein, particularly example 44, wherein the salt comprises a potassium, sodium, or a lithium salt of bis(fluorosulfonyl) imide, trifluoromethanesulfonate, bis(trifluoromethane)sulfonimide, difluoro(oxalato)borate, perchlorate, tetrafluoroborate, hexafluorophosphate, hexafluroarsenate, aluminum tetrachloride, boron tetrachloride iodide, chlorate, borate, iodate, or a combination thereof.

EXAMPLE 46: The electrochemical cell of any one of examples herein, particularly example 44 or 45, wherein the non-aqueous solvent comprises dioxane, ethylene carbonate, dimethyl carbonate, diethyl carbonate, ethyl methyl carbonate, polyoxylene, fluoroethylene carbonate, ethylene carbonate, N-methyl acetamide, acetonitrile, symmetric sulfone, sulfolane, polyethylene glycol, 1,3-dioxolane, glymes, siloxane, ethylene oxide grafted sulfolane, or a combination thereof.

EXAMPLE 47: The electrochemical cell of any one of examples herein, particularly examples 39-46, wherein the cathode is a metal cathode or a composite cathode.

EXAMPLE 48: The electrochemical cell of any one of examples herein, particularly example 47, wherein the cathode comprises copper, carbon, graphite, sodium, potassium, lithium, layered oxides, spinels, olivines, or any combination thereof.

EXAMPLE 49: The electrochemical cell of any one of examples herein, particularly example 47 or 48, wherein the cathode comprises KFe^{II}Fe^{III}(CN)₆, NaFe^{II}Fe^{III}(CN)₆, Na₃V₂(PO₄)₃, LiFePO₄, Li(NiCoMn)O₂, or any combination thereof.

EXAMPLE 50: The electrochemical cell of any one of examples herein, particularly examples 38-49, wherein the cell exhibits a substantially stable plating and stripping for at least about 200 cycles at about 0.5 mA cm⁻² and about 0.5 mAh cm⁻².

EXAMPLE 51: The electrochemical cell of any one of examples herein, particularly examples 38-50, wherein the cell exhibits a substantially stable plating and stripping for at least about 500 cycles at about 0.5 mA cm⁻² and about 0.5 mAh cm⁻².

EXAMPLE 52: The electrochemical cell of any one of examples herein, particularly examples 38-51, wherein the cell exhibits a substantially stable plating and stripping for about 1000 cycles or more at about 0.5 mA cm⁻² and about 0.5 mAh cm⁻².

EXAMPLE 53: The electrochemical cell of any one of examples herein, particularly examples 38-52, wherein the cell exhibits a substantially stable plating and stripping for about 600 cycles or more at about 5 mA cm⁻² and about 1.0 mAh cm⁻².

EXAMPLE 54: The electrochemical cell of any one of examples herein, particularly examples 38-53, exhibiting a capacity greater than about 90 mAh/g after about 100 cycles at a current density of about 50 mA/g.

EXAMPLE 55: The electrochemical cell of any one of examples herein, particularly examples 38-54, wherein the cell exhibits a capacity greater than about 90 mAh/g after about 100 cycles at a current density of about 100 mA/g.

EXAMPLE 56: The electrochemical cell of any one of examples herein, particularly examples 38-55, wherein the electrochemical cell exhibits capacity retention greater than about 90% for at least about 100 cycles.

EXAMPLE 57: The electrochemical cell of any one of examples herein, particularly examples 38-56, wherein the inorganic-based material of the multifunctional structure is substantially non-reactive with the at least one electrode and/or electrolyte.

EXAMPLE 58: The electrochemical cell of any one of examples herein, particularly examples 38-57, wherein the inorganic-based material is at least partially reactive the at least one electrode and/or electrolyte.

EXAMPLE 59: The electrochemical cell of any one of examples herein, particularly example 58, wherein a reaction product of the inorganic-based material is configured to form at least one further layer disposed on the second layer or on the third layer if present.

EXAMPLE 60: The electrochemical cell of any one of examples herein, particularly example 59, wherein the at least one further layer is a solid-electrolyte interphase (SEI) layer.

EXAMPLE 61: The electrochemical cell of any one of examples herein, particularly examples 38-60, wherein the multifunctional structure is substantially smooth after a stripping process as compared to a substantially identical reference electrochemical cell having a substantially identical multifunctional structure in the absence of the inorganic-based material after a substantially identical stripping process.

EXAMPLE 62: The electrochemical cell of any one of examples herein, particularly examples 38-61, wherein the multifunctional structure is substantially smooth after a stripping process as compared to a substantially identical reference electrochemical cell having a substantially identical multifunctional structure in the absence of the inorganic-based material after a substantially identical stripping process.

EXAMPLE 63: A method of making a multifunctional structure comprising depositing an inorganic-based material on at least a first surface of a first layer comprising a first polymer to form a second layer; and wherein the multifunction structure exhibits an ionic conductivity from about 0.1 mS/cm to about 1 S/cm.

EXAMPLE 64: The method of any one of examples herein, particularly example 63, wherein the inorganic-based material is ionically conducting.

EXAMPLE 65: The method of any one of examples herein, particularly examples 63 or 64, wherein the inorganic-based material is electrically insulating.

EXAMPLE 66: The method of any one of examples herein, particularly examples 63-65, wherein the inorganic-based material is semiconducting.

EXAMPLE 67: The method of any one of examples herein, particularly examples 63-66, wherein the step of depositing comprises a magnetron sputtering, wet and dry chemistry, chemical and electrochemical deposition, spin coating, spray drying, tape casting, screen printing, thermal and hydrothermal method, or any combination thereof.

EXAMPLE 68: The method of any one of examples herein, particularly examples 63-67, wherein the first layer is provided as a continuous tape.

EXAMPLE 69: The method of any one of examples herein, particularly examples 63-68, wherein the method further comprises depositing an inorganic-based material on a second surface of the first layer to form a third layer.

EXAMPLE 70: The method of any one of examples herein, particularly example 69, wherein the depositing of the inorganic-based material on the first surface of the first layer and the second surface of the first layer is conducted simultaneously or in a sequence.

EXAMPLE 71: The method of any one of examples herein, particularly examples 63-701, wherein the step of depositing of the inorganic-based material on the first surface and/or the second surface of the first layer is continuous.

EXAMPLE 72: The method of any one of examples herein, particularly examples 63-71, the inorganic-based material comprises at least one of salts, oxides, oxynitrides, sulfides, selenides, phosphides, carbides, nitrides, glass, ceramics, semiconductors, metal and/or alloys thereof, metalloids, intermetallics, or any combination thereof.

EXAMPLE 73: The method of any one of examples herein, particularly examples 63-72, wherein the inorganic-based material comprises one or more of fluorides, chlorides, chlorates, perchlorates, iodates, tetrachloroaluminates, tetrochloroborates, bromates, iodides, phosphates, nitrates, silicates, tellurium, selenium, sulfur, or any combination thereof

EXAMPLE 74: The method of any one of examples herein, particularly examples 72-73, wherein the metal and/or alloys thereof comprise aluminum, magnesium, calcium, potassium, barium, zinc, tin, yttrium, zirconium, lanthanum, gadolinium, scandium, strontium, sodium, lithium, germanium, silicon, aluminum, or any combination thereof.

EXAMPLE 75: The method of any one of examples herein, particularly examples 63-74, wherein the inorganic-based material comprises one or more of AlF₃, Al₂O₃, TiO₂, SiO₂, BaTiO₃, fluorite Gd_{0.1}Ce_{0.9}O_{1.95}, perovskite La_{0.8}Sr_{0.2}Ga_{0.8}Mg_{0.2}O_{2.55}, a metal-organic framework, graphite oxide, graphene oxide, polyhedral oligomeric silsesquioxanes, Li₂CO₃, Li₃PO₄, BN, Li₃S₄, Li₂O, montmorillonite, zeolite, Li₃N, garnet Li₇La₃Zr₂O₁₂ and Li_{6.4}La₃Zr_{1.4}Ta_{0.6}O₁₂, perovskite Li₃ₓLa_{2/3-x}□_{1/3-2x} TiO₃, where □ is a vacancy and 0.06<x<0.14, anti-perovskite Li₃OX, Li₂OHX, wherein X is Cl, Br, or I, NASICONLi₁₊ₓM′ₓM″₂₋ₓ(PO₄)₃, wherein M′ is Al, Sc, or Y, and M″ is Ti or Ge, Li_{1+x+y}Ti₂₋ₓAlₓSi_{y}(PO₄)_{3-y}, halide Li₃X′Cl₆, wherein X′ is Y, In, Zr, Er, or Al, binary sulfide Li₂S—P₂S₅ or Li₂S—MS₂, wherein M is Ge, Si, or Sn, argyrodite Li₆PS₅X, where X is F, Cl, Br, or I, thio-LISICON Li₁₀GeP₂S₁₂, AlN, SiC, Si₃N₄, Sr₂Ce₂Ti₅O₁₆, ZrSiO₄, CaSiO₃, SiO₂, BeO, CeO₂, ZnO, MgO, MgCl, bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (LiI), lithium chlorate (LiClO₃), LiBrO₃, LiIO₃, Lithium trifluoromethanesulfonate (LiTF), Lithium difluoro(oxalato)borate (LiODFB), or any combination thereof.

EXAMPLE 76: The method of any one of examples herein, particularly examples 63-75, wherein the second layer and third layer, if present, further comprises a second polymer.

EXAMPLE 77: The method of any one of examples herein, particularly examples 63-76, wherein the first polymer comprises a polyolefin, polydopamine (PDA), polyimide (PI), polyetherimide (PEI), poly(ethylene terephthalate) (PET), poly(ethylene oxide) (PEO), polyacrylonitrile (PAN), poly(vinyl chloride) (PVC), poly(vinylidene fluoride) (PVDF), polyvinyl butyral (PVB), poly(methyl methacrylate) (PMMA), or any combination thereof.

EXAMPLE 78: The method of any one of examples herein, particularly example 77, wherein the polyolefin comprises polyethylene, polypropylene, or a combination thereof.

EXAMPLE 79: The method of any one of examples herein, particularly examples 69-78, wherein the second layer deposited on the first surface of the first layer comprises a composition that is substantially similar to a composition of the third layer deposited on the second surface of the first layer.

EXAMPLE 80: The method of any one of examples herein, particularly examples 69-79, wherein the second layer deposited on the first surface of the first layer comprises a composition that is substantially different from a composition of the third layer deposited on the second surface of the first layer.

EXAMPLE 81: The method of any one of examples herein, particularly examples 63-80, wherein the second layer comprises a plurality of nanoparticles, a plurality of microparticles, or a combination thereof.

EXAMPLE 82: The method of any one of examples herein, particularly examples 63-81, wherein the second layer has a thickness from about 1μ to about 50μ.

EXAMPLE 83: The method of any one of examples herein, particularly example 82, wherein the thickness of the second layer deposited on the first surface of the first layer is the same or different as the thickness of the third layer deposited on the second surface of the first layer.

EXAMPLE 84: The method of any one of examples herein, particularly examples 63-83, wherein the second layer and the third layer, if present, have a mass loading of the inorganic-based material about 0.5 mg cm⁻² to about 2 mg cm⁻².

EXAMPLE 85: The method of any one of examples herein, particularly examples 84, wherein the mass loading of the inorganic-based material on the first surface of the first layer is the same or different as the mass loading of the inorganic-based material on the second surface of the first layer.

EXAMPLE 86: The method of any one of examples herein, particularly examples 63-85, wherein the second layer and the third layer, if present, have a roughness from about 50 nm rms to about 5 μm rms.

EXAMPLE 87: The method of any one of examples herein, particularly example 86, wherein the roughness of the second layer deposited on the first surface of the first layer is the same or different as the roughness of the third layer deposited on the second surface of the first layer.

EXAMPLE 88: The method of any one of examples herein, particularly examples 81-87, wherein the plurality of nanoparticles or microparticles have a star-like shape, a spheric shape, a non-regular shape, fibrous shape, rod shape, cubic, oval, prism, helical, pillar, or any combination thereof.

EXAMPLE 89: The method of any one of examples herein, particularly examples 81-88, wherein the plurality of nanoparticles or microparticles has an average size from about 10 nm to about 20 μm.

EXAMPLE 90: The method of any one of examples herein, particularly examples 83-89, wherein the multifunctional structure exhibits substantial wettability when exposed to an electrolyte.

EXAMPLE 91: The method of any one of examples herein, particularly example 90, wherein the multifunctional structure exhibits a contact angle from 0° to about 50° when exposed to the electrolyte.

EXAMPLE 92: The method of any one of examples herein, particularly example 90 or 91, wherein the electrolyte comprises a salt and a non-aqueous solvent.

EXAMPLE 93: The method of any one of examples herein, particularly example 92, wherein the salt comprises a potassium, sodium, or a lithium salt of bis(fluorosulfonyl) imide, trifluoromethanesulfonate, bis(trifluoromethane)sulfonimide, difluoro(oxalato)borate, perchlorate, tetrafluoroborate hexafluorophosphate, hexafluroarsenate, aluminum tetrachloride, boron tetrachloride iodide, chlorate, borate, iodate, or a combination thereof.

EXAMPLE 94: The method of any one of examples herein, particularly examples 92 or 93, wherein the non-aqueous solvent comprises dioxane, ethylene carbonate, dimethyl carbonate, diethyl carbonate, ethyl methyl carbonate, polyoxylene, fluoroethylene carbonate, ethylene carbonate, N-methyl acetamide, acetonitrile, symmetric sulfone, sulfolane, polyethylene glycol, 1,3-dioxolane, glymes, siloxane, ethylene oxide grafted sulfolane, or a combination thereof.

EXAMPLE 95: The method of any one of examples herein, particularly examples 63-94, wherein the inorganic-based material is substantially non-reactive when used in an electrochemical cell.

EXAMPLE 96: The method of any one of examples herein, particularly examples 63-95, wherein the inorganic-based material is at least partially reactive when used in an electrochemical cell.

EXAMPLE 97: The method of any one of examples herein, particularly example 96, wherein a reaction product of the inorganic-based material is configured to form at least one further layer disposed on the second layer and/or the third layer if present.

EXAMPLE 98: The method of any one of examples herein, particularly example 97, wherein the at least one further layer is a solid-electrolyte interphase (SEI) layer.

EXAMPLE 99: The method of any one of examples herein, particularly examples 63-98, wherein the multifunctional structure exhibits an ion transference number at least 20% greater than an ion transference number exhibited by a substantially identical reference multifunctional structure in the absence of the second layer and/or third layer, if present, wherein the ion transference number is an ion transference number of K, Na, or Li.

EXAMPLE 100: The method of any one of examples herein, particularly examples 63-99, wherein the multifunctional structure exhibits an ion transference number of greater than 0.5, wherein the ion transference number is an ion transference number of K, Na, or Li.

EXAMPLE 101: The method of any one of examples herein, particularly examples 63-100, wherein the multifunctional structure exhibits an ion conductivity for K, Na, or Li from about 0.1 mS/cm to about 10 mS/cm.

EXAMPLE 102: The method of any one of examples herein, particularly examples 69-101, wherein the second layer deposited on the first surface of the first layer is configured to face an anode, and the third layer deposited on the second surface of the first layer if present is configured to face a cathode when placed into an electrochemical cell.

EXAMPLE 103: The method of any one of examples herein, particularly examples 63-102, wherein the inorganic-based material is deposited by magnetron sputtering, wet and dry chemistry, chemical and electrochemical deposition, spin coating, spray drying, tape casting, screen printing, thermal and hydrothermal method, or any combination thereof.

EXAMPLE 104: A method of forming an electrochemical cell comprising: providing at least one electrode; providing the multifunctional structure of any one of examples herein, particularly examples 1-37, and providing an electrolyte.

EXAMPLE 105: The method of any one of examples herein, particularly example 104, wherein the at least one electrode is an anode and/or cathode.

EXAMPLE 106: The method of any one of examples herein, particularly examples 104 or 105, wherein the electrochemical cell is a battery.

EXAMPLE 107: The method of any one of examples herein, particularly example 106, wherein the battery is a metal battery or ion-metal battery.

EXAMPLE 108: The method of any one of examples herein, particularly examples 106 or 107, wherein the battery is a secondary battery.

EXAMPLE 109: The method of any one of examples herein, particularly examples 104-108, wherein the anode comprises ions and/or metals of potassium, sodium, lithium, or a combination thereof.

EXAMPLE 110: The method of any one of examples herein, particularly examples 104-109, wherein the electrolyte comprises a salt and a non-aqueous solvent.

EXAMPLE 111: The method of any one of examples herein, particularly example 110, wherein the salt comprises a potassium, sodium, or a lithium salt of bis(fluorosulfonyl) imide, trifluoromethanesulfonate, bis(trifluoromethane)sulfonimide, difluoro(oxalato)borate, perchlorate, tetrafluoroborate hexafluorophosphate, hexafluroarsenate, aluminum tetrachloride, boron tetrachloride iodide, chlorate, borate, iodate, or a combination thereof.

EXAMPLE 112: The method of any one of examples herein, particularly examples 110 or 111, wherein the non-aqueous solvent comprises dioxane, ethylene carbonate, dimethyl carbonate, diethyl carbonate, ethyl methyl carbonate, polyoxylene, fluoroethylene carbonate, ethylene carbonate, N-methyl acetamide, acetonitrile, symmetric sulfone, sulfolane, polyethylene glycol, 1,3-dioxolane, glymes, siloxane, ethylene oxide grafted sulfolane, or a combination thereof.

EXAMPLE 113: The method of any one of examples herein, particularly examples 105-112, wherein the cathode is a metal cathode or a composite cathode.

EXAMPLE 114: The method of any one of examples herein, particularly example 113, wherein the cathode comprises copper, carbon, graphite, sodium, potassium, lithium, layered oxides, spinels, olivines, or any combination thereof.

EXAMPLE 115: The method of any one of examples herein, particularly example 113 or 114, wherein the cathode comprises KFe^{II}Fe^{III}(CN)₆, NaFe^{II}Fe^{III}(CN)₆, Na₃V₂(PO₄)₃, LiFePO₄, Li(NiCoMn)O₂, or any combination thereof.

EXAMPLE 116: The method of any one of examples herein, particularly examples 104-115, wherein the cell exhibits a substantially stable plating and stripping for at least about 200 cycles at about 0.5 mA cm⁻² and about 0.5 mAh cm⁻².

EXAMPLE 117: The method of any one of examples herein, particularly examples 104-116, wherein the cell exhibits a substantially stable plating and stripping for at least about 500 cycles at about 0.5 mA cm⁻² and about 0.5 mAh cm⁻².

EXAMPLE 118: The method of any one of examples herein, particularly examples 104-117, wherein the cell exhibits a substantially stable plating and stripping for about 1000 cycles or more at about 0.5 mA cm⁻² and about 0.5 mAh cm⁻².

EXAMPLE 119: The method of any one of examples herein, particularly examples 104-118, wherein the cell exhibits a substantially stable plating and stripping for about 600 cycles or more at about 5 mA cm⁻² and about 1.0 mAh cm⁻².

EXAMPLE 120: The method of any one of examples herein, particularly examples 104-119, wherein the cell exhibits a capacity greater than about 90 mAh/g after about 100 cycles at a current density of about 50 mA/g.

EXAMPLE 121: The method of any one of examples herein, particularly examples 104-120, wherein the cell exhibits a capacity greater than about 90 mAh/g after about 100 cycles at a current density of about 100 mA/g.

EXAMPLE 122: The method of any one of examples herein, particularly example 104-121, wherein the electrochemical cell exhibits a capacity retention greater than about 90% for at least about 100 cycles.

EXAMPLE 123: The method of any one of examples herein, particularly examples 104-122, wherein the multifunctional structure is substantially dendrite-free after a plating process as compared to a substantially identical reference electrochemical cell having a substantially identical multifunctional structure in the absence of the inorganic-based material after a substantially identical plating process.

EXAMPLE 124: The method of any one of examples herein, particularly examples 104-123, wherein the multifunctional structure is substantially smooth after a stripping process compared to a substantially identical reference electrochemical cell having a substantially identical multifunctional structure in the absence of the inorganic-based material after a substantially identical stripping process.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus-or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### References

[1] L. Xue, Y. Li, H. Gao, W. Zhou, X. Lu, W. Kaveevivitchai, A. Manthiram, J. B. Goodenough, J Am Chem Soc 2017, 139, 2164.

[2] T. Hosaka, K. Kubota, A. S. Hameed, S. Komaba, Chem Rev 2020, 10.1021/acs.chemrev.9b00463.

[3] P. Liu, D. Mitlin, Acc Chem Res 2020, 53, 1161.

[4] W. Zhang, Y. Liu, Z. Guo, Sci Adv 2019, 5, eaav7412.

[5] P. Liu, Y. Wang, H. Hao, S. Basu, X. Feng, Y. Xu, J. A. Boscoboinik, J. Nanda, J. Watt, D. Mitlin, Adv Mater 2020, 32, e2002908.

[6] a) J. B. Goodenough, Y. Kim, Chemistry of Materials 2010, 22, 587; b) A. Laurent, N. Espinosa, Energy Environ. Sci., 2015, 8, 689; c) M. Armand, J. M. Tarascon, Nature 2008, 451, 652; d) C. Vaalma, D. Buchholz, M. Weil, S. Passerini, Nature Reviews Materials 2018, 3, 18013; e) J. Deng, W.-B. Luo, S.-L. Chou, H.-K. Liu, S.-X. Dou, Advanced Energy Materials 2018, 8, 1701428; f) R. Schmuch, R. Wagner, G. Hörpel, T. Placke, M. Winter, Nature Energy 2018, 3, 267.

[7] J. Y. Hwang, S. T. Myung, Y. K. Sun, Chem Soc Rev 2017, 46, 3529.

[8] a) A. Eftekhari, ACS Sustainable Chemistry & Engineering 2019, 7, 5602; b) A. Eftekhari, Z. Jian, X. Ji, ACS Appl Mater Interfaces 2017, 9, 4404; c) Y. Wu, H. B. Huang, Y. Feng, Z. S. Wu, Y. Yu, Adv Mater 2019, 31, 1901414; d) H. Kim, J. C. Kim, M. Bianchini, D.-H. Seo, J. Rodriguez-Garcia, G. Ceder, Advanced Energy Materials 2018, 8, 1702384; e) S. Kim, S. Qu, R. Zhang, P. V. Braun, Small 2019, 15, e1900258; f) J. B. Goodenough, Acc Chem Res 2013, 46, 1053; g) J. Ding, H. Zhang, H. Zhou, J. Feng, X. Zheng, C. Zhong, E. Paek, W. Hu, D. Mitlin, Adv Mater 2019, 31, e1900429; h) K. Share, A. P. Cohn, R. Carter, B. Rogers, C. L. Pint, ACS Nano 2016, 10, 9738; i) R. Jain, P. Hundekar, T. Deng, X. Fan, Y. Singh, A. Yoshimura, V. Sarbada, T. Gupta, A. S. Lakhnot, S. O. Kim, C. Wang, N. Koratkar, ACS Nano 2019, 13, 14094; j) Q. Zhang, Z. Wang, S. Zhang, T. Zhou, J. Mao, Z. Guo, Electrochemical Energy Reviews 2018, 1, 625.

[9] a) U. S. G. Survey, in U.S. Geological Survey: Mineral Commodity Summaries, Vol. 200 p (Ed: A. C. Tolcin), Reston, VA 2020, https://doi.org/10.3133/mcs2020; b) P. Sun, X. Li, J. Shao, P. V. Braun, Adv Mater 2021, 33, e2006229; c) S. Kim, J. Choi, S. M. Bak, L. Sang, Q. Li, A. Patra, P. V. Braun, Advanced Functional Materials 2019, 29, 1901719.

[10] a) S. Komaba, T. Hasegawa, M. Dahbi, K. Kubota, Electrochemistry Communications 2015, 60, 172; b) K. Kubota, M. Dahbi, T. Hosaka, S. Kumakura, S. Komaba, Chem Rec 2018, 18, 459; c) K. Chihara, A. Katogi, K. Kubota, S. Komaba, Chem Commun (Camb) 2017, 53, 5208; d) J. Zheng, Y. Yang, X. Fan, G. Ji, X. Ji, H. Wang, S. Hou, M. R. Zachariah, C. Wang, Energy & Environmental Science 2019, 12, 615; e) C. Wang, L. Wang, F. Li, F. Cheng, J. Chen, Adv Mater 2017, 29, 1702212; f) Y. Wu, S. Hu, R. Xu, J. Wang, Z. Peng, Q. Zhang, Y. Yu, Nano Lett 2019, 19, 1351; g) H. Gao, T. Zhou, Y. Zheng, Q. Zhang, Y. Liu, J. Chen, H. Liu, Z. Guo, Advanced Functional Materials 2017, 27, 1702634; h) Y. Liu, Z. Tai, J. Zhang, W. K. Pang, Q. Zhang, H. Feng, K. Konstantinov, Z. Guo, H. K. Liu, Nat Commun 2018, 9, 3645; i) W. Wang, B. Jiang, C. Qian, F. Lv, J. Feng, J. Zhou, K. Wang, C. Yang, Y. Yang, S. Guo, Adv Mater 2018, 30, e1801812; j) C. Yang, J. Feng, F. Lv, J. Zhou, C. Lin, K. Wang, Y. Zhang, Y. Yang, W. Wang, J. Li, S. Guo, Adv Mater 2018, 30, e1800036; k) Y. Dong, Z. S. Wu, S. Zheng, X. Wang, J. Qin, S. Wang, X. Shi, X. Bao, ACS Nano 2017, 11, 4792; l) C. Zeng, F. Xie, X. Yang, M. Jaroniec, L. Zhang, S. Z. Qiao, Angew Chem Int Ed Engl 2018, 57, 8540; m) Z. Ju, P. Li, G. Ma, Z. Xing, Q. Zhuang, Y. Qian, Energy Storage Materials 2018, 11, 38; n) Z. Chen, D. Yin, M. Zhang, Small 2018, 14, e1703818; o) K. Share, A. P. Cohn, R. E. Carter, C. L. Pint, Nanoscale 2016, 8, 16435; p) R. A. Adams, A. Varma, V. G. Pol, Advanced Energy Materials 2019, 9, 1900550; q) J. R. Rodriguez, S. B. Aguirre, V. G. Pol, Journal of Power Sources 2019, 437, 226851; r) Z. Jian, W. Luo, X. Ji, J Am Chem Soc 2015, 137, 11566; s) W. Luo, J. Wan, B. Ozdemir, W. Bao, Y. Chen, J. Dai, H. Lin, Y. Xu, F. Gu, V. Barone, L. Hu, Nano Lett 2015, 15, 7671; t) Z. Jian, S. Hwang, Z. Li, A. S. Hernandez, X. Wang, Z. Xing, D. Su, X. Ji, Advanced Functional Materials 2017, 27, 1700324; u) P. Xiong, X. Han, X. Zhao, P. Bai, Y. Liu, J. Sun, Y. Xu, ACS Nano 2019, 13, 2536.

[11] H. Wang, D. Yu, C. Kuang, L. Cheng, W. Li, X. Feng, Z. Zhang, X. Zhang, Y. Zhang, Chem 2019, 5, 313.

[12] P. Liu, Y. Wang, Q. Gu, J. Nanda, J. Watt, D. Mitlin, Adv Mater 2020, 32, e1906735.

[13] N. Xiao, W. D. McCulloch, Y. Wu, J Am Chem Soc 2017, 139, 9475.

[14] Y. Li, L. Zhang, S. Liu, X. Wang, D. Xie, X. Xia, C. Gu, J. Tu, Nano Energy 2019, 62, 367.

[15] a) W. Liu, P. Liu, D. Mitlin, Advanced Energy Materials 2020, 10.1002/aenm.202002297; b) W. Liu, P. Liu, D. Mitlin, Chem Soc Rev 2020, 10.1039/docs00867b.

[16] C. Wei, Y. Tao, H. Fei, Y. An, Y. Tian, J. Feng, Y. Qian, Energy Storage Materials 2020, 10.1016/j.ensm.2020.05.018.

[17] X. Tang, D. Zhou, P. Li, X. Guo, B. Sun, H. Liu, K. Yan, Y. Gogotsi, G. Wang, Adv Mater 2020, 32, e1906739.

[18] E. Peled, S. Menkin, Journal of The Electrochemical Society 2017, 164, A1703.

[19] Y. Gu, W. W. Wang, Y. J. Li, Q. H. Wu, S. Tang, J. W. Yan, M. S. Zheng, D. Y. Wu, C. H. Fan, W. Q. Hu, Z. B. Chen, Y. Fang, Q. H. Zhang, Q. F. Dong, B. W. Mao, Nat Commun 2018, 9, 1339.

[20] a) X. B. Cheng, R. Zhang, C. Z. Zhao, Q. Zhang, Chem Rev 2017, 117, 10403; b) J. Liu, Z. Bao, Y. Cui, E. J. Dufek, J. B. Goodenough, P. Khalifah, Q. Li, B. Y. Liaw, P. Liu, A. Manthiram, Y. S. Meng, V. R. Subramanian, M. F. Toney, V. V. Viswanathan, M. S. Whittingham, J. Xiao, W. Xu, J. Yang, X.-Q. Yang, J.-G. Zhang, Nature Energy 2019, 4, 180; c) Y. Zhao, K. Zheng, X. Sun, Joule 2018, 2, 2583; d) Y. Zhao, M. Amirmaleki, Q. Sun, C. Zhao, A. Codirenzi, L. V. Goncharova, C. Wang, K. Adair, X. Li, X. Yang, F. Zhao, R. Li, T. Filleter, M. Cai, X. Sun, Matter 2019, 1, 1215; e) W. Liu, Y. Xia, W. Wang, Y. Wang, J. Jin, Y. Chen, E. Paek, D. Mitlin, Advanced Energy Materials 2019, 9, 1802918; f) W. Wang, F. Hao, P. P. Mukherjee, ACS Appl Mater Interfaces 2020, 12, 556; g) L. Liu, Y. X. Yin, J. Y. Li, S. H. Wang, Y. G. Guo, L. J. Wan, Adv Mater 2018, 30, 1706216; h) S. H. Wang, Y. X. Yin, T. T. Zuo, W. Dong, J. Y. Li, J. L. Shi, C. H. Zhang, N. W. Li, C. J. Li, Y. G. Guo, Adv Mater 2017, 29, 1703729; i) F. Hao, A. Verma, P. P. Mukherjee, Energy Storage Materials 2019, 20, 1; j) L. Wang, J. Bao, Q. Liu, C.-F. Sun, Energy Storage Materials 2019, 18, 470; k) F. Hao, W. Wang, P. P. Mukherjee, Journal of The Electrochemical Society 2020, 167, 080513; l) D. Lin, Y. Liu, Y. Cui, Nat Nanotechnol 2017, 12, 194; m) X. Li, Z. Ren, M. Norouzi Banis, S. Deng, Y. Zhao, Q. Sun, C. Wang, X. Yang, W. Li, J. Liang, X. Li, Y. Sun, K. Adair, R. Li, Y. Hu, T.-K. Sham, H. Huang, L. Zhang, S. Lu, J. Luo, X. Sun, ACS Energy Letters 2019, 4, 2480; n) W. Luo, Y. Zhang, S. Xu, J. Dai, E. Hitz, Y. Li, C. Yang, C. Chen, B. Liu, L. Hu, Nano Lett 2017, 17, 3792; Y. Zhang, C. Wang, G. Pastel, Y. Kuang, H. Xie, Y. Li, B. Liu, W. Luo, C. Chen, L. Hu, Advanced Energy Materials 2018, 8, 1800635; o) X. Hu, P. H. Joo, H. Wang, E. Matios, C. Wang, J. Luo, X. Lu, K. Yang, W. Li, Advanced Functional Materials 2019, 29, 1807974; p) J. Luo, C. Wang, H. Wang, X. Hu, E. Matios, X. Lu, W. Zhang, X. Tao, W. Li, Advanced Functional Materials 2019, 29, 1805946; q) D. Geng, N. Ding, T. S. A. Hor, S. W. Chien, Z. Liu, D. Wuu, X. Sun, Y. Zong, Advanced Energy Materials 2016, 6, 1502164; r) Y. Zhao, K. R. Adair, X. Sun, Energy & Environmental Science 2018, 11, 2673; B. Lee, E. Paek, D. Mitlin, S. W. Lee, Chem Rev 2019, 119, 5416; s) X. Lin, Y. Sun, Q. Sun, J. Luo, Y. Zhao, C. Zhao, X. Yang, C. Wang, H. Huo, R. Li, X. Sun, Advanced Energy Materials 2021, 11, 2003789; t) X. Hu, E. Matios, Y. Zhang, C. Wang, J. Luo, W. Li, Angew Chem Int Ed Engl 2021, 60, 5978; u) K. Moyer, C. Meng, B. Marshall, O. Assal, J. Eaves, D. Perez, R. Karkkainen, L. Roberson, C. L. Pint, Energy Storage Materials 2020, 24, 676; v) W. Ping, C. Wang, Z. Lin, E. Hitz, C. Yang, H. Wang, L. Hu, Advanced Energy Materials 2020, 10, 2000702; w) G. Zhong, C. Wang, R. Wang, W. Ping, S. Xu, H. Qiao, M. Cui, X. Wang, Y. Zhou, D. J. Kline, M. R. Zachariah, L. Hu, Energy Storage Materials 2020, 30, 385.

[21] S. Liu, J. Mao, Q. Zhang, Z. Wang, W. K. Pang, L. Zhang, A. Du, V. Sencadas, W. Zhang, Z. Guo, Angew Chem Int Ed Engl 2020, 59, 3638.

[22] H. Wang, D. Yu, X. Wang, Z. Niu, M. Chen, L. Cheng, W. Zhou, L. Guo, Angew Chem Int Ed Engl 2019, 58, 16451.

[23] a) T. Hosaka, S. Muratsubaki, K. Kubota, H. Onuma, S. Komaba, J Phys Chem Lett 2019, 10, 3296; b) W. Zhang, W. K. Pang, V. Sencadas, Z. Guo, Joule 2018, 2, 1534.

[24] a) M. Ye, J. Y. Hwang, Y. K. Sun, ACS Nano 2019, 13, 9306; b) H. W. Wang, J. Y. Hu, J. H. Dong, K. C. Lau, L. Qin, Y. Lei, B. H. Li, D. Y. Zhai, Y. Y. Wu, F. Y. Kang, Advanced Energy Materials 2019, 9, 1902697.

[25] L. Qin, Y. Lei, H. Wang, J. Dong, Y. Wu, D. Zhai, F. Kang, Y. Tao, Q. H. Yang, Advanced Energy Materials 2019, 9, 1901427.

[26] X. Zhao, F. Chen, J. Liu, M. Cheng, H. Su, J. Liu, Y. Xu, Journal of Materials Chemistry A 2020, 8, 5671.

[27] a) P. Hundekar, S. Basu, X. Fan, L. Li, A. Yoshimura, T. Gupta, V. Sarbada, A. Lakhnot, R. Jain, S. Narayanan, Y. Shi, C. Wang, N. Koratkar, Proceedings of the National Academy of Sciences 2020, 10.1073/pnas.1915470117, 201915470; b) L. Li, S. Basu, Y. Wang, Z. Chen, P. Hundekar, B. Wang, J. Shi, Y. Shi, S. Narayanan, N. Koratkar, Science 2018, 359, 1513.

[28] C. M. Costa, Y.-H. Lee, J.-H. Kim, S.-Y. Lee, S. Lanceros-Mendez, Energy Storage Materials 2019, 22, 346.

[29] C. Z. Zhao, P. Y. Chen, R. Zhang, X. Chen, B. Q. Li, X. Q. Zhang, X. B. Cheng, Q. Zhang, Sci Adv 2018, 4, eaat3446.

[30] R. Pan, X. Xu, R. Sun, Z. Wang, J. Lindh, K. Edstrom, M. Stromme, L. Nyholm, Small 2018, 14, e1704371.

[31] H. Lee, X. Ren, C. Niu, L. Yu, M. H. Engelhard, I. Cho, M.-H. Ryou, H. S. Jin, H.-T. Kim, J. Liu, W. Xu, J.-G. Zhang, Advanced Functional Materials 2017, 27, 1704391.

[32] a) K. Liu, D. Zhuo, H. W. Lee, W. Liu, D. Lin, Y. Lu, Y. Cui, Adv Mater 2017, 29, 1603987; b) Z. Tang, S. Li, Y. Li, H. Xu, Y. Yu, Y. Huang, J. Li, Nano Energy 2020, 69, 104399; c) Y. He, S. Wu, Q. Li, H. Zhou, Small 2019, 15, e1904332.

[33] Y. J. Kim, H. Lee, H. Noh, J. Lee, S. Kim, M. H. Ryou, Y. M. Lee, H. T. Kim, ACS Appl Mater Interfaces 2017, 9, 6000.

[34] a) J. Liu, R. Xu, C. Yan, H. Yuan, J.-F. Ding, Y. Xiao, T.-Q. Yuan, J.-Q. Huang, Energy Storage Materials 2020, 30, 27; b) X. Ni, T. Qian, X. Liu, N. Xu, J. Liu, C. Yan, Advanced Functional Materials 2018, 28, 1706513; c) F. A. Susai, H. Sclar, Y. Shilina, T. R. Penki, R. Raman, S. Maddukuri, S. Maiti, I. C. Halalay, S. Luski, B. Markovsky, D. Aurbach, Adv Mater 2018, 30, e1801348; d) Z. Hu, F. Liu, J. Gao, W. Zhou, H. Huo, J. Zhou, L. Li, Advanced Functional Materials 2019, 30, 1907020; e) X. Li, L. Yuan, D. Liu, M. Liao, J. Chen, K. Yuan, J. Xiang, Z. Li, Y. Huang, Advanced Functional Materials 2021, 10.1002/adfm.202100537, 2100537; f) D. Lin, D. Zhuo, Y. Liu, Y. Cui, J Am Chem Soc 2016, 138, 11044; g) W. Luo, L. Zhou, K. Fu, Z. Yang, J. Wan, M. Manno, Y. Yao, H. Zhu, B. Yang, L. Hu, Nano Lett 2015, 15, 6149; h) W. Liu, Z. Chen, Z. Zhang, P. Jiang, Y. Chen, E. Paek, Y. Wang, D. Mitlin, Energy & Environmental Science 2021, 14, 382.

[35] a) J. Liang, Q. Chen, X. Liao, P. Yao, B. Zhu, G. Lv, X. Wang, X. Chen, J. Zhu, Angew Chem Int Ed Engl 2020, 10.1002/anie.201915440; b) D. Zhou, R. Liu, Y.-B. He, F. Li, M. Liu, B. Li, Q.-H. Yang, Q. Cai, F. Kang, Advanced Energy Materials 2016, 6, 1502214.

[36] a) J.-Y. Hwang, H. M. Kim, S. Shin, Y.-K. Sun, Advanced Functional Materials 2018, 28, 1704294; b) Q. Wang, J. Yang, Z. Wang, L. Shi, Y. Zhao, S. Yuan, Energy Technology 2020, 8, 1901429.

[37] J. Yan, F. Liu, Z. Hu, J. Gao, W. Zhou, H. Huo, J. Zhou, L. Li, Nano Lett 2020, 20, 3798.

[38] a) R. N. Wenzel, Industrial & Engineering Chemistry 1936, 28, 988; b) R. N. Wenzel, The Journal of Physical and Colloid Chemistry 1949, 53, 1466; c) C. H. Kung, P. K. Sow, B. Zahiri, W. Mérida, Advanced Materials Interfaces 2019, 6, 1900839; d) S. Zhang, J. Huang, Z. Chen, S. Yang, Y. Lai, Journal of Materials Chemistry A 2019, 7, 38; e) Y. Sun, Z. Guo, Nanoscale Horizons 2019, 4, 52.

[39] B. Su, Y. Tian, L. Jiang, J Am Chem Soc 2016, 138, 1727.

[40] a) T. Young, Philosophical Transactions of the Royal Society of London 1805, 95, 65; b) Z. Liang, D. Lin, J. Zhao, Z. Lu, Y. Liu, C. Liu, Y. Lu, H. Wang, K. Yan, X. Tao, Y. Cui, Proc Natl Acad Sci USA 2016, 113, 2862.

[41] a) H. Lee, M. Yanilmaz, O. Toprakci, K. Fu, X. Zhang, Energy Environ. Sci. 2014, 7, 3857; b) H. Zhang, X. Wang, Y. Liang, Heliyon 2015, 1, e00032.

[42] a) M. Dahbi, D. Violleau, F. Ghamouss, J. Jacquemin, F. Tran-Van, D. Lemordant, M. Anouti, Industrial & Engineering Chemistry Research 2012, 51, 5240; b) S. Beyer, O. Kobsch, D. Pospiech, F. Simon, C. Peter, K. Nikolowski, M. Wolter, B. Voit, Journal of Adhesion Science and Technology 2019, 34, 849.

[43] R. Pandharkar, C. Becker, J. Budau, Z. Kaawar, B. Paulus, Inorganics 2018, 6, 124.

[44] J. Wu, Z. Liu, F. Wang, C. Ren, Journal of Chemical & Engineering Data 2003, 48, 1571.

[45] a) O. G. Bagmut, Functional materials 2019, 26, 6; b) L. Guo, G. Oskam, A. Radisic, P. M. Hoffmann, P. C. Searson, Journal of Physics D: Applied Physics 2011, 44, 443001.

[46] a) J. Conder, C. Villevieille, Chem Commun (Camb) 2019, 55, 1275; b) Z. Tu, S. Choudhury, M. J. Zachman, S. Wei, K. Zhang, L. F. Kourkoutis, L. A. Archer, Nature Energy 2018, 3, 310; c) X. Zheng, H. Fu, C. Hu, H. Xu, Y. Huang, J. Wen, H. Sun, W. Luo, Y. Huang, J Phys Chem Lett 2019, 10, 707.

[47] P. Albertus, S. Babinec, S. Litzelman, A. Newman, Nature Energy 2017, 3, 16.

[48] T. Masese, K. Yoshii, M. Kato, K. Kubota, Z. D. Huang, H. Senoh, M. Shikano, Chem Commun (Camb) 2019, 55, 985.

[49] a) K. N. Wood, G. Teeter, ACS Applied Energy Materials 2018, 1, 4493; b) S. Oswald, F. Thoss, M. Zier, M. Hoffmann, T. Jaumann, M. Herklotz, K. Nikolowski, F. Scheiba, M. Kohl, L. Giebeler, D. Mikhailova, H. Ehrenberg, Batteries 2018, 4, 36; c) S. Stankovich, D. A. Dikin, R. D. Piner, K. A. Kohlhaas, A. Kleinhammes, Y. Jia, Y. Wu, S. T. Nguyen, R. S. Ruoff, Carbon 2007, 45, 1558; d) D. Yang, A. Velamakanni, G. Bozoklu, S. Park, M. Stoller, R. D. Piner, S. Stankovich, I. Jung, D. A. Field, C. A. Ventrice, R. S. Ruoff, Carbon 2009, 47, 145; e) A. Siokou, F. Ravani, S. Karakalos, O. Frank, M. Kalbac, C. Galiotis, Applied Surface Science 2011, 257, 9785; f) L. Stobinski, B. Lesiak, A. Malolepszy, M. Mazurkiewicz, B. Mierzwa, J. Zemek, P. Jiricek, I. Bieloshapka, Journal of Electron Spectroscopy and Related Phenomena 2014, 195, 145.

[50] Q. Zhang, J. Mao, W. K. Pang, T. Zheng, V. Sencadas, Y. Chen, Y. Liu, Z. Guo, Advanced Energy Materials 2018, 8, 1703288.

[51] L. Deng, Y. Zhang, R. Wang, M. Feng, X. Niu, L. Tan, Y. Zhu, ACS Appl Mater Interfaces 2019, 11, 22449.

[52] a) A. C. Kozen, C. F. Lin, A. J. Pearse, M. A. Schroeder, X. Han, L. Hu, S. B. Lee, G. W. Rubloff, M. Noked, ACS Nano 2015, 9, 5884; b) Y. Zhao, L. V. Goncharova, A. Lushington, Q. Sun, H. Yadegari, B. Wang, W. Xiao, R. Li, X. Sun, Adv Mater 2017, 29, 1606663.

[53] Materials Project. https://materialsproject.org/.

[54] S. Chong, Y. Chen, Y. Zheng, Q. Tan, C. Shu, Y. Liu, Z. Guo, Journal of Materials Chemistry A 2017, 5, 22465.

[55] W. Liu, Y. Mi, Z. Weng, Y. Zhong, Z. Wu, H. Wang, Chem Sci 2017, 8, 4285.

[56] M. Ye, J. Y. Hwang, Y. K. Sun, ACS Nano 2019, 13, 9306.

[57] T. Hosaka, S. Muratsubaki, K. Kubota, H. Onuma, S. Komaba, J Phys Chem Lett 2019, 10, 3296.

1. (canceled)

2. A multifunctional structure comprising:
a first layer comprising a first polymer and having a first surface and a second surface,
a second layer comprising an inorganic-based material deposited on at least the first surface of the first layer, wherein the inorganic-based material is ionically conducting and/or electrically insulating and/or semiconducting and wherein the multifunctional structure is an electrochemical cell separator, and
optionally a third layer comprising an inorganic-based material deposited on the second surface of the first layer

3-4. (canceled)

5. The multifunctional structure of claim 2, wherein the second layer further comprises a second polymer different from the first polymer.

6. The multifunctional structure of claim 2, wherein the inorganic-based material comprises:
at least one of salts, oxides, oxynitrides, sulfides, selenides, phosphides, carbides, nitrides, glass, ceramics, semiconductors, metal and/or alloys thereof, metalloids, intermetallics, or any combination thereof, wherein the metal and/or alloys thereof comprise aluminum, magnesium, calcium, potassium, barium, zinc, tin, yttrium, zirconium, lanthanum, gadolinium, scandium, strontium, sodium, lithium, germanium, silicon, aluminum, or any combination thereof; and/or
one or more of fluorides, chlorides, chlorates, perchlorates, iodates, tetrachloroaluminates, tetrochloroborates, bromates, iodides, phosphates, nitrates, silicates, tellurium, selenium, sulfur, or any combination thereof.

7-9. (canceled)

10. The multifunctional structure of claim 2, wherein the first polymer comprises a polyolefin, polydopamine (PDA), polyimide (PI), polyetherimide (PEI), poly(ethylene terephthalate) (PET), poly(ethylene oxide) (PEO), polyacrylonitrile (PAN), poly(vinyl chloride) (PVC), poly(vinylidene fluoride) (PVDF), polyvinyl butyral (PVB), poly(methyl methacrylate) (PMMA), or any combination thereof.

11. (canceled)

12. The multifunctional structure of claim 2, wherein the third layer is present and wherein:
the second layer deposited on the first surface of the first layer comprises a composition that is substantially similar to a composition of the third layer deposited on the second surface of the first layer, or
wherein the second layer deposited on the first surface of the first layer comprises a composition that is substantially different from a composition of the third layer deposited on the second surface of the first layer

13-15. (canceled)

16. The multifunction structure of claim 2, wherein the second layer and the third layer, if present, comprise a plurality of nanoparticles, a plurality of microparticles, or a combination thereof, have a thickness from about 1μ to about 50μ, and/or wherein the second layer and the third layer, when present, have a mass loading of the inorganic-based material about 0.5 mg cm⁻² to about 2 mg cm⁻², and the second layer and the third layer, when present, have a roughness from about 50 nm rms to about 5 μm rms.

17-24. (canceled)

25. The multifunction structure of claim 2, wherein the multifunctional structure exhibits a contact angle from 0° to about 50° when exposed to the electrolyte comprising a salt and a non-aqueous solvent.

26-29. (canceled)

30. The multifunction structure of claim 2, wherein the inorganic-based material is at least partially reactive when used in an electrochemical cell, and wherein a reaction product of the inorganic-based material is configured to form a solid-electrolyte interphase (SEI) layer disposed on the second layer and/or the third layer, when present.

31-33. (canceled)

34. The multifunctional structure of claim 2, wherein the multifunctional structure exhibits an ion transference number of greater than 0.5, wherein the ion transference number is an ion transference number of K, Na, or Li.

35-37. (canceled)

38. An electrochemical cell comprising:
at least one electrode, wherein the at least one electrode is an anode and/or cathode;
a separator comprising the multifunctional structure of claim 2; and
an electrolyte.

39-42. (canceled)

43. The electrochemical cell of claim 38, wherein the anode comprises ions and/or metals of potassium, sodium, lithium, or a combination thereof.

44. The electrochemical cell of claim 38, wherein the electrolyte comprises a salt and a non-aqueous solvent, wherein
the salt comprises a potassium, sodium, or a lithium salt of bis(fluorosulfonyl) imide, trifluoromethanesulfonate, bis(trifluoromethane)sulfonimide, difluoro(oxalato)borate, perchlorate, tetrafluoroborate, hexafluorophosphate, hexafluroarsenate, aluminum tetrachloride, boron tetrachloride iodide, chlorate, borate, iodate, or a combination thereof; and wherein
the non-aqueous solvent comprises dioxane, ethylene carbonate, dimethyl carbonate, diethyl carbonate, ethyl methyl carbonate, polyoxylene, fluoroethylene carbonate, ethylene carbonate, N-methyl acetamide, acetonitrile, symmetric sulfone, sulfolane, polyethylene glycol, 1,3-dioxolane, glymes, siloxane, ethylene oxide grafted sulfolane, or a combination thereof.

45-46. (canceled)

47. The electrochemical cell of claim 38, wherein the cathode is a metal cathode or a composite cathode.

48. (canceled)

49. The electrochemical cell of claim 47, wherein the cathode comprises KFe^{II}Fe^{III}(CN)₆, NaFe^{II} Fe^{III}(CN)₆, Na₃V₂(PO₄)₃, LiFePO₄, Li(NiCoMn)O₂, or any combination thereof

50. The electrochemical cell of claim 38, wherein the cell exhibits a substantially stable plating and stripping for at least about 200 cycles at about 0.5 mA cm⁻² and about 0.5 mAh cm⁻², and/or wherein the cell exhibits a substantially stable plating and stripping for about 600 cycles or more at about 5 mA cm⁻² and about 1.0 mAh cm⁻².

51-53. (canceled)

54. The electrochemical cell of claim 38, exhibiting a capacity greater than about 90 mAh/g after about 100 cycles at a current density of about 50 mA/g, and/or wherein the cell exhibits a capacity greater than about 90 mAh/g after about 100 cycles at a current density of about 100 mA/g; and/or wherein the electrochemical cell exhibits a capacity retention greater than about 90% for at least about 100 cycles.

55-57. (canceled)

58. The electrochemical cell of claim 38, wherein the inorganic-based material is at least partially reactive the at least one electrode and/or electrolyte, and wherein a reaction product of the inorganic-based material is configured to form a solid-electrolyte interphase (SEI) layer disposed on the second layer or on the third layer, when present.

59-62. (canceled)

63. A method of making a multifunctional structure comprising:
depositing an inorganic-based material on at least a first surface of a first layer comprising a first polymer to form a second layer;
wherein the multifunction structure exhibits an ionic conductivity from about 0.1 mS/cm to about 1 S/cm; and
wherein the inorganic-based material is ionically conducting, and/or the inorganic-based material is electrically insulating, and/or the inorganic-based material is semiconducting.

64-66. (canceled)

67. The method of claim 63, wherein the step of depositing comprises a magnetron sputtering, wet and dry chemistry, chemical and electrochemical deposition, spin coating, spray drying, tape casting, screen printing, thermal and hydrothermal method, or any combination thereof.

68. The method of claim 63, wherein the first layer is provided as a continuous tape.

69-74. (canceled)

75. The method of claim 63, wherein the inorganic-based material comprises one or more of AlF₃, Al₂O₃, TiO₂, SiO₂, BaTiO₃, fluorite Gd_{0.1}Ce_{0.9}O_{1.95}, perovskite La_{0.8}Sr_{0.2}Ga_{0.8}Mg_{0.2}O_{2.55}, a metal-organic framework, graphite oxide, graphene oxide, polyhedral oligomeric silsesquioxanes, Li₂CO₃3, Li₃PO₄, BN, Li₃S₄, Li₂O, montmorillonite, zeolite, Li₃N, garnet Li₇La₃Zr₂O₁₂ and Li_{6.4}La₃Zr_{1.4}Ta_{0.6}O₁₂, perovskite Li₃ₓLa_{2/3-x}□_{1/3-2x}TiO₃, where is a vacancy and 0.06<x<0.14, anti-perovskite Li₃OX, Li₂OHX, wherein X is Cl, Br, or I, NASICONLi₁₊ₓM′ₓM″₂₋ₓ(PO₄)₃, wherein M′ is Al, Sc, or Y, and M″ is Ti or Ge, Li_{1+x+y}Ti₂₋ₓAlₓSi_{y}, (PO₄)_{3-y}, halide Li₃X′Cl₆, wherein X′ is Y, In, Zr, Er, or Al, binary sulfide Li₂S—P₂S₅ or Li₂S—MS₂, wherein M is Ge, Si, or Sn, argyrodite Li₆PS₅X, where X is F, Cl, Br, or I, thio-LISICON Li₁₀GeP₂S₁₂, AlN, SiC, Si₃N₄, Sr₂Ce₂Ti₅O₁₆, ZrSiO₄, CaSiO₃, SiO₂, BeO, CeO₂, ZnO, MgO, MgCl, bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (LiI), lithium chlorate (LiClO₃), LiBrO₃, LiIO₃, Lithium trifluoromethanesulfonate (LiTF), Lithium difluoro(oxalato)borate (LiODFB), or any combination thereof.

76-103. (canceled)

104. A method of forming an electrochemical cell comprising:
providing at least one electrode;
providing the multifunctional structure of claim 2; and
providing an electrolyte.

105-124. (canceled)
